(19) United States
(12) Patent Application Publication
(10) Pub. No.: US 2025/0240140 A1
(43) Pub. Date: Jul. 24, 2025

(54) INDEPENDENT SOUNDING FOR TWO OR MORE RF MODULES FOR INCREASED EIRP

(71) Applicant: QUALCOMM Incorporated, San Diego, CA (US)

(72) Inventors: Satish KUMAR, Hyderabad (IN); Chaitanya Kumar MATCHA, Hyderabad (IN)

(21) Appl. No.: 18/420,639

(22) Filed: Jan. 23, 2024

(51) Int. Cl. H04L 5/00; H04B 7/06; H04W 72/231

(52) U.S. Cl. CPC H04L 5/0051; H04B 7/0626; H04W 72/231

(57) ABSTRACT

Independent sounding for two or more RF modules for increased EIRP is described. An apparatus is configured to receive, from a network node, a CSI configuration. The CSI configuration is indicative of a format associated with at least one CSI report. The apparatus is configured to receive multiple CSI-RS transmissions during at least one CSI-RS occasion. The multiple CSI-RS transmissions include a CSI-RS from each logically combined set of antenna modules of the network node. The apparatus is configured to provide, for the network node, the at least one CSI report based on the format associated with the at least one CSI report and based on the CSI-RS. The at least one CSI report is indicative of at least one of a relative timing offset associated with the multiple CSI-RS transmissions or a relative phase offset associated with the multiple CSI-RS transmissions during the at least one CSI-RS occasion.

### TECHNICAL FIELD

The present disclosure relates generally to communication systems, and more particularly, to wireless communications utilizing multiple radio frequency (RF) modules.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. That apparatus may be or may be included with a user equipment (UE). The apparatus is configured to receive, from a network node, a channel state information (CSI) configuration, where the CSI configuration is indicative of a format associated with at least one CSI report. The apparatus is configured to receive multiple channel state information reference signal (CSI-RS) transmissions during at least one CSI-RS occasion, where the multiple CSI-RS transmissions include a CSI-RS from each logically combined set of antenna modules of the network node. The apparatus is configured to provide, for the network node, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion.

In the aspects, the method includes receiving, from a network node, a CSI configuration, where the CSI configuration is indicative of a format associated with at least one CSI report. The method includes receiving multiple CSI-RS transmissions during at least one CSI-RS occasion, where the multiple CSI-RS transmissions include a CSI-RS from each logically combined set of antenna modules of the network node. The method includes providing, for the network node, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion.

In another aspect of the disclosure, a method, a computer-readable medium, and an apparatus are provided. The apparatus is configured to provide, for a UE, a CSI configuration, where the CSI configuration is indicative of a format associated with at least one CSI report. The apparatus is configured to provide, for the UE, multiple CSI-RS transmissions during at least one CSI-RS occasion, where the multiple CSI-RS transmissions include a CSI-RS from each logically combined set of antenna modules of the network node. The apparatus is configured to receive, from the UE, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion.

In the aspects, the method includes providing, for a UE, a CSI configuration, where the CSI configuration is indicative of a format associated with at least one CSI report. The method includes providing, for the UE, multiple CSI-RS transmissions during at least one CSI-RS occasion, where the multiple CSI-RS transmissions include a CSI-RS from each logically combined set of antenna modules of the network node. The method includes receiving, from the UE, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of wireless communications utilizing multiple RF modules.

FIG. 5 is a call flow diagram for wireless communications, in accordance with various aspects of the present disclosure.

FIG. 6 is a diagram illustrating examples of a CSI report and independent sounding for two or more RF modules for increased effective isotropic radiated power (EIRP), in accordance with various aspects of the present disclosure.

FIG. 7 is a diagram illustrating examples independent sounding for two or more RF modules for increased EIRP, in accordance with various aspects of the present disclosure.

FIG. 8 is a diagram illustrating examples independent sounding for two or more RF modules for increased EIRP, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks may be designed to support communications between network nodes (e.g., base stations, gNBs, etc.) and UEs. For instance, a network node and a UE in a wireless communication network may communicate in various communication configurations and using various communication components. As one example, a modem communicatively coupled to one or more antenna modules may transmit/receive wireless communications for network devices. Such communications may be transmitted according to an EIRP, and the EIRP may be limited by the hardware of communication components. Some configurations may combine communication components in an attempt to boost the EIRP.

However, while the module alignment and factory calibration may provide for beams combining coherently, multi-path aspects of communications may still prevent signals from being received in-phase in order to provide a full amount of gain from communication components, such as two grouped RF modules. Additionally, without the flexibility to pre-code signals of two or more combined communication components in the digital domain, e.g., to have the signals be received in-phase, the benefit of the combination is reduced. For example, when the same data/signal is transmitted through combined communication components, such as for two layers scheduled for a UE, theoretically there may be a 2-port CSI-RS configuration for the UE to report the CSI back to the base station/gNB.

Various aspects relate generally to wireless communications utilizing multiple RF modules. Some aspects more specifically relate to independent sounding for two or more RF modules for increased EIRP. In some examples, a UE may receive multiple CSI-RS transmissions, such as a CSI-RS from logically combined sets of antenna modules of a network node, during a CSI-RS occasion(s), and provide, for the network node, a CSI report(s) based on a CSI configuration and the CSI-RS. The CSI report(s) is indicative of a relative timing offset and/or a relative phase offset associated with the multiple CSI-RS transmissions during the CSI-RS occasion(s). In one example, the CSI report(s) is more than one CSI report, such as when a number of CSI-RS ports configured at the UE is less than a number of physical ports of the logically combined sets of antenna modules, which provides indicia of the relative timing offset and/or the relative phase offset, and the network node may calculate a timing offset and/or a phase offset of its antenna modules and provide the UE with an indication thereof. In one example, the CSI report(s) is one CSI report, such as when the number of CSI-RS ports configured at the UE is equal to the number of physical ports, which provides the relative timing offset and/or the relative phase offset measured by the UE, and the network node may calculate a timing offset and/or a phase offset of its antenna modules and provide the UE with an indication thereof.

Particular aspects of the subject matter described in this disclosure can be implemented to realize one or more of the following potential advantages. In one example, by enabling beams to combine coherently using independent sounding for two or more RF modules, the described techniques can be used to increase EIRP with existing communication components. In one example, by increasing the EIRP, the described techniques can be used to enhance in cell coverage and cell capacity with high throughput (e.g., multi-layer) transmissions, increase reliability, and reduce cost for UE/base station operations. In one example, by providing extensibility for the number of RF modules combined and carrier aggregation, the described techniques can be used to improve adaptability per-UE for EIRP increases through timing/phase offset correction across antenna modules/ports.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

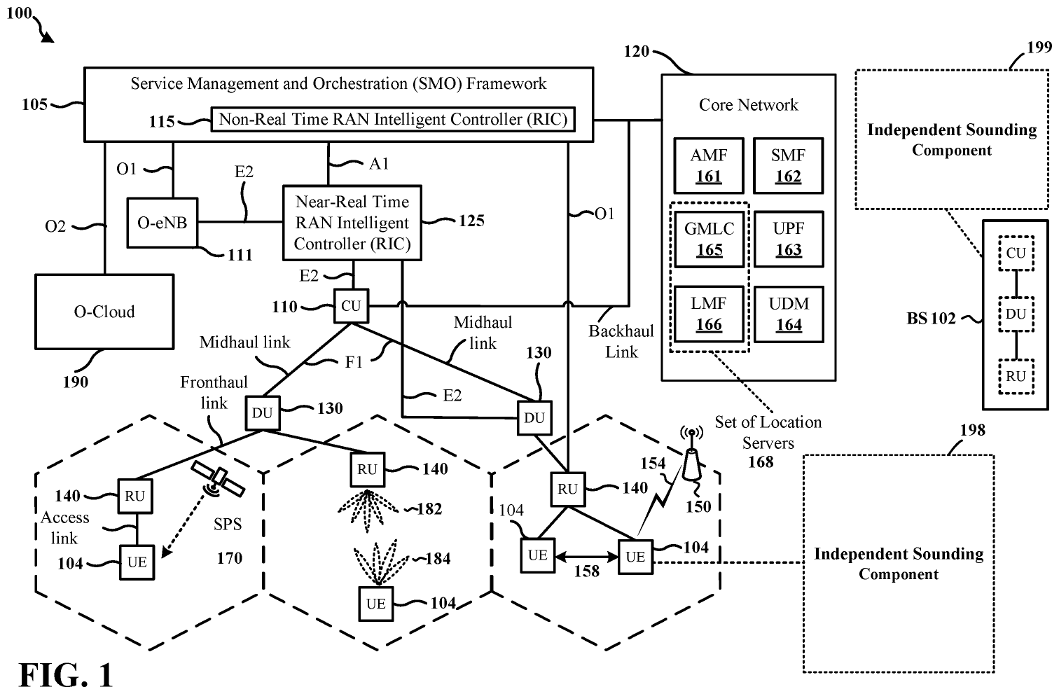

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an independent sounding component 198 (“component 198”) that may be configured to receive, from a network node, a CSI configuration, where the CSI configuration is indicative of a format associated with at least one CSI report. The component 198 may be configured to receive multiple CSI-RS transmissions during at least one CSI-RS occasion, where the multiple CSI-RS transmissions include a CSI-RS from each logically combined set of antenna modules of the network node. The component 198 may be configured to provide, for the network node, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion. The component 198 may be configured to receive, from the network node, a physical downlink shared channel (PDSCH) from the logically combined set of antenna modules, where at least one of a timing offset or a phase offset between multiple antenna modules of the logically combined set of antenna modules is based on the at least one CSI report. The component 198 may be configured to receive, from the network node, an indication of the at least one of the timing offset, the phase offset, or an index to a data structure that comprises at least one of discrete timing or phase offset values associated with an RRC procedure. The component 198, to receive the multiple CSI-RS transmissions during the at least one CSI-RS occasion, may be configured to receive a first CSI-RS from a first pair of antennas of the network node during the first CSI-RS occasion, receive a second CSI-RS from a second pair of antennas of the network node during the second CSI-RS occasion, where the second pair of antennas is different from the first pair of antennas, and measure at least one of the relative timing offset associated with the CSI-RS or the relative phase offset associated with the first CSI-RS and the second CSI-RS. The component 198 may be configured to provide, for the network node, uplink signaling indicative of the relative timing offset associated with the multiple CSI-RS transmissions, where the uplink signaling includes at least one of a sounding reference signal (SRS) or a physical uplink shared channel (PUSCH) demodulation reference signal (DMRS). The component 198, to receive the multiple CSI-RS transmissions during the at least one CSI-RS occasion, may be configured to receive a first instance of the CSI-RS, by the first pair of ports of the number of ports and from a first pair of antennas of the network node, during the first CSI occasion, receive a second instance of the CSI-RS, by the second pair of ports of the number of ports and from a second pair of antennas of the network node, during the second CSI occasion subsequent to the first CSI occasion, and measure at least one of the relative timing offset associated with the CSI-RS or the relative phase offset associated with the CSI-RS at the first instance of the CSI-RS and at the second instance of the CSI-RS. The component 198 may be configured to provide, for the network node via the at least one transceiver, uplink signaling indicative of the relative timing offset associated with the first instance of the CSI-RS and with the second instance of the CSI-RS, where the uplink signaling includes at least one of a SRS or a PUSCH DMRS.

In certain aspects, the base station 102 may have an independent sounding component 199 (“component 199”) that may be configured to provide, for a UE, a CSI configuration, where the CSI configuration is indicative of a format associated with at least one CSI report. The component 199 may be configured to provide, for the UE, multiple CSI-RS transmissions during at least one CSI-RS occasion, where the multiple CSI-RS transmissions include a CSI-RS from each logically combined set of antenna modules of the network node. The component 199 may be configured to receive, from the UE, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion. The component 199 may be configured to calculate at least one of a timing offset or a phase offset between multiple antenna modules of the logically combined set of antenna modules based on the at least one CSI report. The component 199 may be configured to provide, for the UE, a PDSCH from the logically combined set of antenna modules, where at least one of the timing offset or the phase offset between the multiple antenna modules of the logically combined set of antenna modules. The component 199 may be configured to provide, for the UE, an indication of the at least one of the timing offset, the phase offset, or an index to a data structure that comprises at least one of discrete timing or phase offset values associated with an RRC procedure. The component 199, to provide the multiple CSI-RS transmissions during the at least one CSI-RS occasions, may be configured to provide a first CSI-RS from a first pair of antennas of the network node during the first CSI-RS occasion, and provide a second CSI-RS from a second pair of antennas of the network node during the second CSI-RS occasion, where the second pair of antennas is different from the first pair of antennas, where at least one of the relative timing offset associated with the multiple CSI-RS transmissions or the relative phase offset associated with the multiple CSI-RS transmissions is associated with the first CSI-RS and the second CSI-RS. The component 199 may be configured to receive, from the UE, uplink signaling indicative of the relative timing offset associated with the multiple CSI-RS transmissions, where the uplink signaling includes at least one of a SRS or a PUSCH DMRS. The component 199, to provide the multiple CSI-RS transmissions during the at least one CSI-RS occasion, may be configured to provide a first instance of the CSI-RS, by the first pair of ports of the number of ports and from a first pair of antennas of the network node, during the first CSI occasion, and provide a second instance of the CSI-RS, by the second pair of ports of the number of ports and from a second pair of antennas of the network node, during the second CSI occasion subsequent to the first CSI occasion, where at least one of the relative timing offset associated with the CSI-RS or the relative phase offset associated with the CSI-RS is associated with the first instance of the CSI-RS and at the second instance of the CSI-RS. The component 199 may be configured to receive, from the UE via the at least one transceiver, uplink signaling indicative of the relative timing offset associated with the first instance of the CSI-RS and with the second instance of the CSI-RS, where the uplink signaling includes at least one of a SRS or a PUSCH DMRS.

Accordingly, aspects herein for independent sounding for two or more RF modules for increased EIRP and may enable a UE to receive CSI-RS transmissions and provide indicia to a network node of relative CSI-RS timing/phase offsets associated with its logically combined sets of antenna modules such that the network node may implement timing/phase offsets therefor, and notify the UE thereof, to allow coherent combinations of beams received at the UE and increase EIRP.

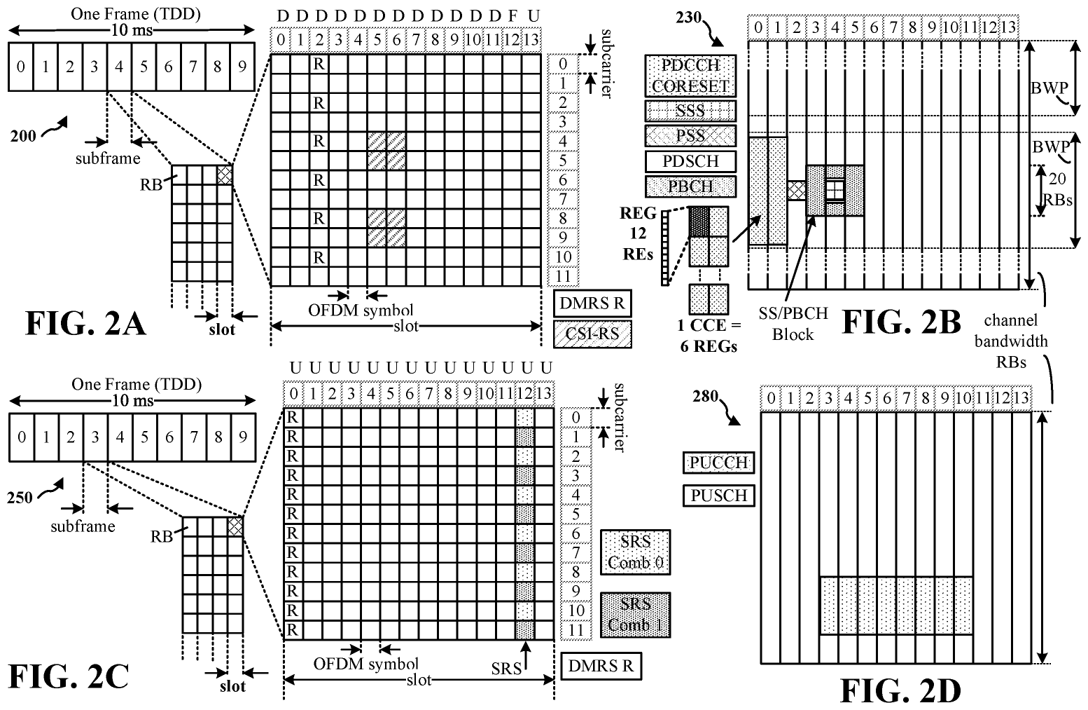

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

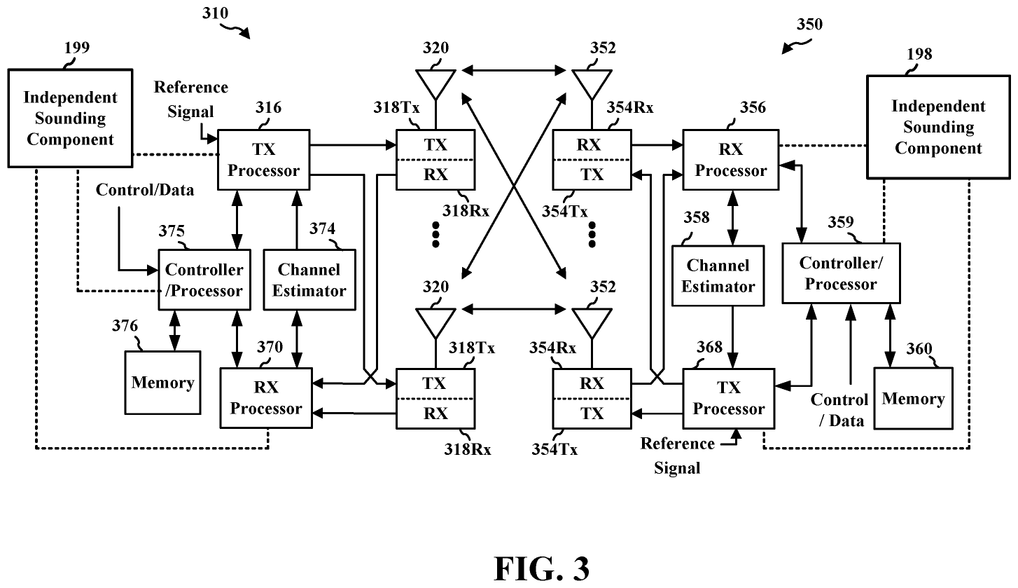

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A network node, such as a base station, gNB, etc., and a UE in a wireless communication network may communicate in various communication configurations and using various communication components. As one example, a modem communicatively coupled to one or more antenna modules may transmit/receive wireless communications for network devices. Such communications may be transmitted according to an EIRP, and the EIRP may be limited by the hardware of communication components. Some configurations may combine communication components in an attempt to boost the EIRP.

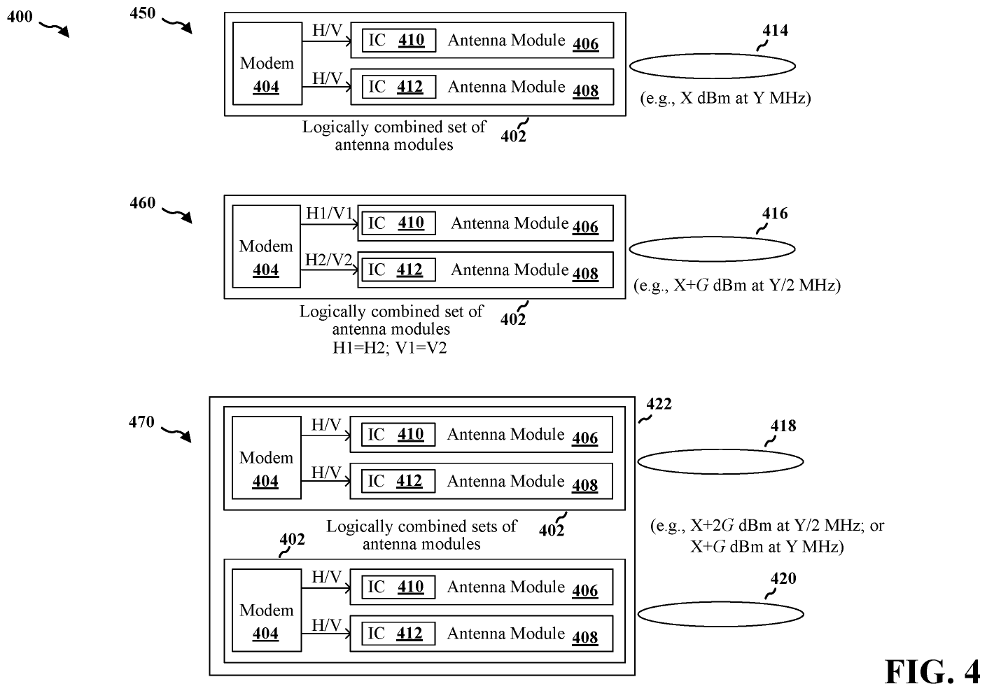

FIG. 4 is a diagram 400 illustrating an example of wireless communications utilizing multiple RF modules. Diagram 400 includes a configuration 450, a configuration 460, and a configuration 470, shown in the context of instances of a logically combined set of antenna modules 402, which comprises hardware components. Each of the logically combined set of antenna modules 402 is shown as including a modem 404 (e.g., which may support high-band operations where beam forming is utilized, such as FR2/FR4/mmW bands/etc.), an antenna module 406 having an integrated circuit (IC) controller 410, and an antenna module 408 having an IC controller 412. While two antenna elements are included, by way of example, for brevity and illustrative clarity, other numbers of antenna elements may be present, and likewise, additional instances of the modem 404 may also be present.

The IC controller 410 and the IC controller 412 may respectively control/configure a number of antenna elements for the antenna module 406 and the antenna module 408. The modem 404 may provide data/information (e.g., from layer 1) to each of the antenna module 406 and the antenna module 408 (e.g., for layer 2). Such data may include a first layer associated with horizontal polarization (H) and a second layer associated with vertical polarization (V), and transmission thereof may be respectively controlled/configured by the IC controller 410 and the IC controller 412.

As shown in the configuration 450, the logically combined set of antenna modules 402 may be configured to support an EIRP of a given value, e.g., ‘X’ dBm, at a given operating bandwidth, e.g., ‘Y’ MHz, with two layers, e.g., H/V, for a transmitted beam 414.

In the configuration 460, where the horizontal and vertical polarizations are configured to be equal for the antenna module 406 and the antenna module 408, the logically combined set of antenna modules 402 may be configured to support an increased EIRP of the given value, e.g., ‘X’ dBm, plus an increase, e.g., ‘G’ dBm, at half of the given operating bandwidth, e.g., ‘Y/2’ MHz, with two layers, e.g., H/V, for a transmitted beam 416. For example, calibration and beam management may be utilized for the transmitted beam 416 of the antenna module 406 and the antenna module 408 to coherently combine and provide the increase of ‘G’ dBm at transmission.

In the configuration 470, logically combined sets of antenna modules 422, e.g., including two instances of the logically combined set of antenna modules 402, may be configured to support an increased EIRP of the given value, e.g., ‘X’ dBm, plus an increase, e.g., ‘2G’ dBm, at half the given operating bandwidth, e.g., ‘Y/2’ MHz, or to support an increased EIRP of the given value, e.g., ‘X’ dBm, plus an increase, e.g., ‘G’ dBm, at the given operating bandwidth, e.g., ‘Y’ MHz, with two layers, e.g., H/V, for a transmitted beam 418 and a transmitted beam 420 together. For example, calibration and beam management (e.g., joint beamforming for intra-modem and separate beamforming for inter-modem) may be utilized for the transmitted beam 418 of a first instance of the antenna module 406 and the antenna module 408, and for the transmitted beam 420 of a second instance of the antenna module 406 and the antenna module 408, to coherently combine and provide the increase of ‘2G’ dBm or ‘G’ at transmission over half the operating bandwidth ‘Y/2’ or the operating bandwidth ‘Y’, respectively.

However, as noted herein, module alignment and factory calibration may provide for beams combining coherently, yet multi-path aspects of communications may still prevent signals from being received in-phase in order to provide a full amount of gain from communication components, such as two grouped RF modules. Additionally, the lack of flexibility to pre-code signals of two or more combined communication components in the digital domain, e.g., to have the signals be received in-phase, prevents the full benefit of the combination from being realized. For example, when the same data/signal is transmitted through combined communication components, such as for two layers scheduled for a UE, theoretically there will be a 2-port CSI-RS configuration for the UE to report the CSI back to the base station/gNB.

The aspects herein provide for the conversion of a two-transmit antenna system to a four-transmit antenna system by incorporating two RF modules (e.g., two modules of two transmit antennas) together. The aspects provide for gain (e.g., 3 dB) from a precoder: timing and phase offsets between the two RF modules. The timing and phase offsets are communicated to a UE via a medium access control (MAC) control element (MAC-CE). Configuring a single 4-port CSI-RS, a first CSI-RS occasion is utilized to determine a channel of the first RF module (e.g., refraining from sending anything on the second RF module), and a CSI-RS second occasion is utilized to estimate a channel of second RF module (refraining from sending anything on the first RF module). The combined precoder is then determined based on the information reported by the UE, such as in a CSI report. Configuring two 2-port CSI-RSs, the information is utilized independently from both 2-port CSI-RSs to determine the precoder.

The aspects herein provide for independent sounding for two or more RF modules for increased EIRP. In some examples, a UE may receive multiple CSI-RS transmissions, such as a CSI-RS from logically combined sets of antenna modules of a network node, during a CSI-RS occasion(s), and provide, for the network node, a CSI report(s) based on a CSI configuration and the CSI-RS. The CSI report(s) is indicative of a relative timing offset and/or a relative phase offset associated with the multiple CSI-RS transmissions during the CSI-RS occasion(s). In one example, the CSI report(s) is more than one CSI report, such as when a number of CSI-RS ports configured at the UE is less than a number of physical ports of the logically combined sets of antenna modules, which provides indicia of the relative timing offset and/or the relative phase offset, and the network node may calculate a timing offset and/or a phase offset of its antenna modules and provide the UE with an indication thereof. In one example, the CSI report(s) is one CSI report, such as when the number of CSI-RS ports configured at the UE is equal to the number of physical ports, which provides the relative timing offset and/or the relative phase offset measured by the UE, and the network node may calculate a timing offset and/or a phase offset of its antenna modules and provide the UE with an indication thereof. Aspects increase EIRP with existing communication components by enabling beams to combine coherently using independent sounding for two or more RF modules. Aspects also enhance in cell coverage and cell capacity with high throughput (e.g., multi-layer) transmissions, e.g., for UEs at a cell edge), increase reliability, and reduce cost for UE/base station operations by increasing the EIRP. Aspects further improve adaptability per-UE for EIRP increases through timing/phase offset correction across antenna modules/ports by providing extensibility for the number of RF modules combined and carrier aggregation.

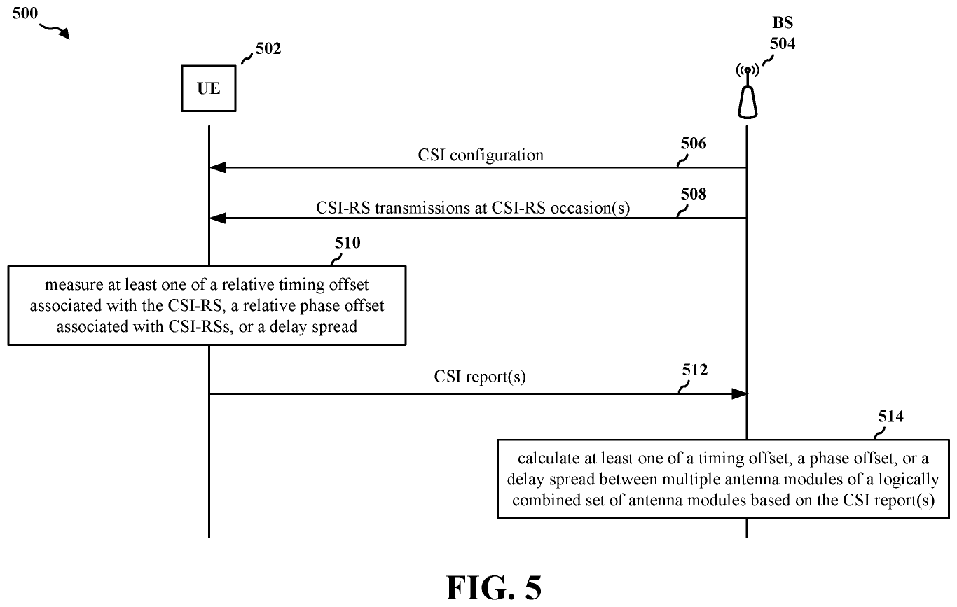

FIG. 5 is a call flow diagram 500 for wireless communications, in various aspects. Call flow diagram 500 illustrates independent sounding for two or more RF modules for increased EIRP at a UE (e.g., a UE 602, by way of example) that may be configured to communicate with a network node (e.g., one or more components of a base station 604, such as a gNB or other type of base station, by way of example, as shown). Aspects described for base stations may be performed by base station 504 in aggregated form and/or by one or more components of the base station in disaggregated form. Additionally, or alternatively, the aspects may be performed by the UE 502 autonomously, in addition to, and/or in lieu of, operations of the base station 504.

As noted herein, it may be beneficial for a UE (e.g., the UE 502) to provide a report (e.g., associated with a logically combined set(s) of antenna modules of a network node (e.g., the base station 504), as illustrated by way of example in FIG. 4 (e.g., the logically combined set of antenna modules 402, the logically combined sets of antenna modules 422)), combined or independent CSI information for utilization in pre-coding data of each logically combined set of antenna modules without the UE determining a physical arrangement association with different RF/antenna modules at the network node. In aspects, the CSI information reported by the UE may include, along with default CSI metrics: a relative timing offset of signals from the signal coming for two or more logically combined sets of antenna modules, a relative phase offset of signals from the two logically combined sets of antenna modules, and/or a delay spread. In aspects, the UE may be configured to measure the relative timing offset based on a first set of two reference signals and a second set of two reference signals in scenarios for two logically combined sets of antenna modules. In aspects, the UE may be configured to measure the relative phase offset based on a first set of two reference signals and second set of two reference signals in in scenarios for two logically combined sets of antenna modules. A UE may be configured to apply its default mechanism to report the delay spread or may be configured to use the strongest channel tap to report an associated CSI metric to the network node. The network node may be configured to use the timing advance (TA)/phase report from the UE in its CSI for correction at layer 2 for DL signaling.

In the illustrated aspect, the UE 502 may be configured to receive, and a network node (e.g., the base station 504) may be configured to transmit/provide, a CSI configuration 506. The CSI configuration 506 may be indicative of a format associated with at least one CSI report 512. As an example, the CSI configuration 506 may indicate to, or configure, the UE 502 for a number ‘M’ of CSI-RS ports, types of metrics to be included in the at least one CSI report 512 per the format, a periodicity for transmitting/providing the at least one CSI report 512, and/or the like.

The UE 502 may be configured to receive, and a network node (e.g., the base station 504) may be configured to transmit/provide, multiple CSI-RS transmissions 508 during at least one CSI-RS occasion. The multiple CSI-RS transmissions 508 may include a CSI-RS from each logically combined set of antenna modules of the network node. In aspects, CSI-RS transmissions of the multiple CSI-RS transmissions 508 may be transmitted/provided at a first CSI-RS occasion (e.g., at a time T₁) and/or at a second CSI-RS occasion (e.g., at a time T₂), and may be associated with respective beams. The CSI-RS occasion on which CSI-RS transmissions of the multiple CSI-RS transmissions 508 are transmitted/provided may be based on a number ‘M’ of CSI-RS ports configured at the UE 502 and a number ‘N’ of physical ports of the logically combined sets of antenna modules (e.g., having a number ‘N/2’ of logical ports and two layers) at the base station 504. In some aspects, when the number ‘M’ of CSI-RS ports configured at the UE 502 is less than the number ‘N’ of physical ports of the logically combined sets of antenna modules (e.g., having a number ‘N/2’ of logical ports and two layers) at the base station 504, first CSI-RS transmissions of the multiple CSI-RS transmissions 508 may be transmitted/provided at the first CSI-RS occasion at time T₁, and second CSI-RS transmissions of the multiple CSI-RS transmissions 508 may be transmitted/provided at the second CSI-RS occasion at time T₂. In some aspects, when the number ‘M’ of CSI-RS ports configured at the UE 502 is equal to the number ‘N’ of physical ports of the logically combined sets of antenna modules at the base station 504, the multiple CSI-RS transmissions 508 may be transmitted/provided at the first CSI-RS occasion at time T₁.

The UE 502 may be configured to measure (at 510) at least one of a relative timing offset associated with the CSI-RS, a relative phase offset associated with CSI-RSs, or a delay spread. In aspects, UE 502 may be configured to measure (at 510) at least one of (i) the relative timing offset associated with a CSI-RS from each logically combined set of antenna modules of the network node (e.g., the base station 504) or (ii) the relative phase offset associated with a first CSI-RS and a second CSI-RS of the multiple CSI-RS transmissions 508. As an example, the multiple CSI-RS transmissions 508 received by the UE 502 may be received at different times and/or with different phases by an antenna module(s) of the UE 502. The UE 502 may be configured to measure the differences in reception times/phases, in aspects, and the UE 502 may be configured to identify the different times/phases, in other aspects. In either of these aspects, the differences of the times/phases (e.g., for a single CSI report) or the different times/phases (e.g., for a multiple CSI reports) may be included in the at least one CSI report 512.

The UE 502 may be configured to transmit/provide, and the network node (e.g., the base station 504) may be configured to receive, the at least one CSI report 512 based on the format associated with the at least one CSI report 512 and based on the CSI-RS. The at least one CSI report 512 may be indicative of at least one of a relative timing offset associated with the multiple CSI-RS transmissions 508 or a relative phase offset associated with the multiple CSI-RS transmissions 508 during the at least one CSI-RS occasion. In aspects, at least one CSI report 512 may be indicative of a relative timing offset and/or a relative phase offset associated with the multiple CSI-RS transmissions 508 during the CSI-RS occasion(s). In aspects, the at least one CSI report 512 may indicate the relative timing offset, the relative phase offset, and/or the delay spread.

The network node (e.g., the base station 504) may be configured to calculate (at 514) at least one of a timing offset, a phase offset, or a delay spread between multiple antenna modules of a logically combined set of antenna modules based on the at least one CSI report 512. In one example, the at least one CSI report 512 may be more than one CSI report, such as when a number of CSI-RS ports configured at the UE 502 is less than a number of physical ports of the logically combined sets of antenna modules, which provides indicia of the relative timing offset and/or the relative phase offset, and the network node (e.g., the base station 504) may calculate (at 514) a timing offset and/or a phase offset of its antenna modules and provide the UE 502 with an indication thereof. In one example, the at least one CSI report 512 may be one CSI report, such as when the number of CSI-RS ports configured at the UE 502 is equal to the number of physical ports, which provides the relative timing offset and/or the relative phase offset measured by the UE 502, and the network node (e.g., the base station 504) may calculate (at 514) a timing offset and/or a phase offset of its antenna modules and provide the UE 502 with an indication thereof.

The UE 502 may be configured to receive, and a network node (e.g., the base station 504) may be configured to transmit/provide, a PDSCH from the logically combined set of antenna modules. In aspects, at least one of the timing offset or the phase offset between multiple antenna modules of the logically combined set of antenna modules may be based on the at least one CSI report 512. The UE 502 may be configured to receive, and a network node (e.g., the base station 504) may be configured to transmit/provide, an indication of the at least one of the timing offset or the phase offset.

As the CSI-RS channel is common for multiple UEs in a wideband allocation for a network node (e.g., a base station, gNB, etc.), correction applied by the network node to dedicated configurations (e.g., PDSCH) for a UE, per its CSI report, may also be communicated back to the UE itself. In this way, the UE is enabled to understand or be aware of how much delta is applied to its dedicated data with respect to the CSI-RS. Accordingly, aspects may provide for the indication of such information of time difference applied per TRP as a MAC-CE in PDSCH data. The value in the MAC-CE may point to a table which may indicate a delta applied to one TRP with respect to another TRP, and may be extended to multi-TRP systems.

Additionally, aspects may be extended to cases where multiple antenna ports are from the same logically combined set of antenna modules. In such configurations, the network node may be configured to correct the timing offset of signals coming from the multiple antenna ports, while correcting the phase offset from multiple antenna ports may be performed using the precoder. Antenna ports from the same logically combined set of antenna modules may be quasi co-located, e.g., the UE may be configured/enabled to make assumptions on the similarity of channel propagation conditions.

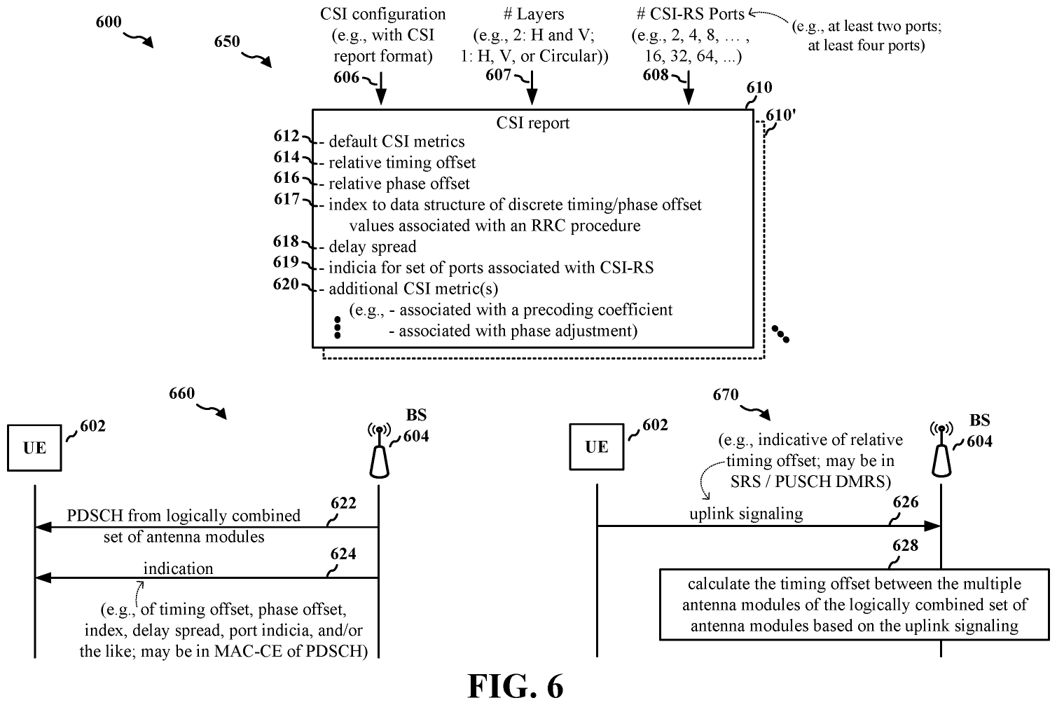

FIG. 6 is a diagram 600 illustrating examples of a CSI report and independent sounding for two or more RF modules for increased EIRP, in various aspects. Diagram 600 shows a configuration 650 for a CSI report(s) 610, as well as a configuration 660 and a configuration 670 in the context of a UE 602 and a network node (e.g., a base station 604, a gNB, etc.).

In the configuration 650, the CSI report(s) 610 is illustrated. The CSI report(s) 610 may be an aspect of the at least one CSI report 512 in FIG. 5, described above. The CSI report(s) 610 may be based on one or more of a CSI configuration 606 (e.g., that may include a CSI report format, such as for an aspect of the CSI configuration 506 in FIG. 5), a number of layers 607 (e.g., 2 layers: for horizontal polarization and vertical polarization; 1 layer: horizontal polarization, vertical polarization, or circular polarization (e.g., in such aspects, each antenna module may transmit with both horizontal and vertical polarization for 1 layer), and/or a number of ports 608 (e.g., 2, 4, 8, . . . , 16, 32, 64, 128, . . . , etc.; also, at least two ports in some aspects, at least four ports in some aspects, etc.)). The CSI report(s) 610 may include a single CSI report as the CSI report(s) 610, or may include multiple CSI reports (e.g., including at least one additional CSI report 610′). In aspects, the number of CSI reports included in the CSI report(s) 610 may be associated with the relationship of the number of CSI ports configured for the UE 602 (e.g., in the CSI configuration 606) and the number of physical ports for CSI-RS at the base station 604 (e.g., the number of logical ports*2 layers).

In aspects, the CSI report(s) 610 may include, without limitation, one or more CSI metrics of: default CSI metrics 612, a relative timing offset 614 (e.g., associated with multiple CSI-RS transmissions), a relative phase offset 616 (e.g., associated with multiple CSI-RS transmissions), an index 617 to a data structure, e.g., a table or list, that comprises at least one of discrete timing or phase offset values associated with an RRC procedure (e.g., preconfigured during the RRC procedure), a delay spread 618, an indication/indicia 619 for a set of ports associated with the multiple CSI-RS transmissions (e.g., an identifier(s), port number(s), etc.), an additional CSI metric(s) 620 (e.g., associated with a precoding coefficient, associated with a phase adjustment, etc.), and/or the like.

In the configuration 660, the UE 602 may be configured to receive, and the network node (e.g., the base station 604) may be configured to transmit/provide, a PDSCH 622 from the logically combined set of antenna modules. In aspects, at least one of the timing offset or the phase offset between multiple antenna modules of the logically combined set of antenna modules may be based on the CSI report(s) 610. The UE 602 may be configured to receive, and the network node (e.g., the base station 604) may be configured to transmit/provide, an indication 624 that may comprise the at least one of the timing offset or the phase offset. In aspects, the indication 624 may include the delay spread. The indication 624 may be included in a MAC-CE of the PDSCH 622. That is, the correction applied by the base station 604 to dedicated configurations (e.g., the PDSCH 622) for the UE 602, per the CSI report(s) 610, may also be communicated back to the UE 602 itself, and in this way, the UE 602 may be enabled to understand or be aware of how much delta is applied to its dedicated data (e.g., data transmitted/provided to the UE 602 but not to other UEs served by the base station 604) with respect to the CSI-RS.

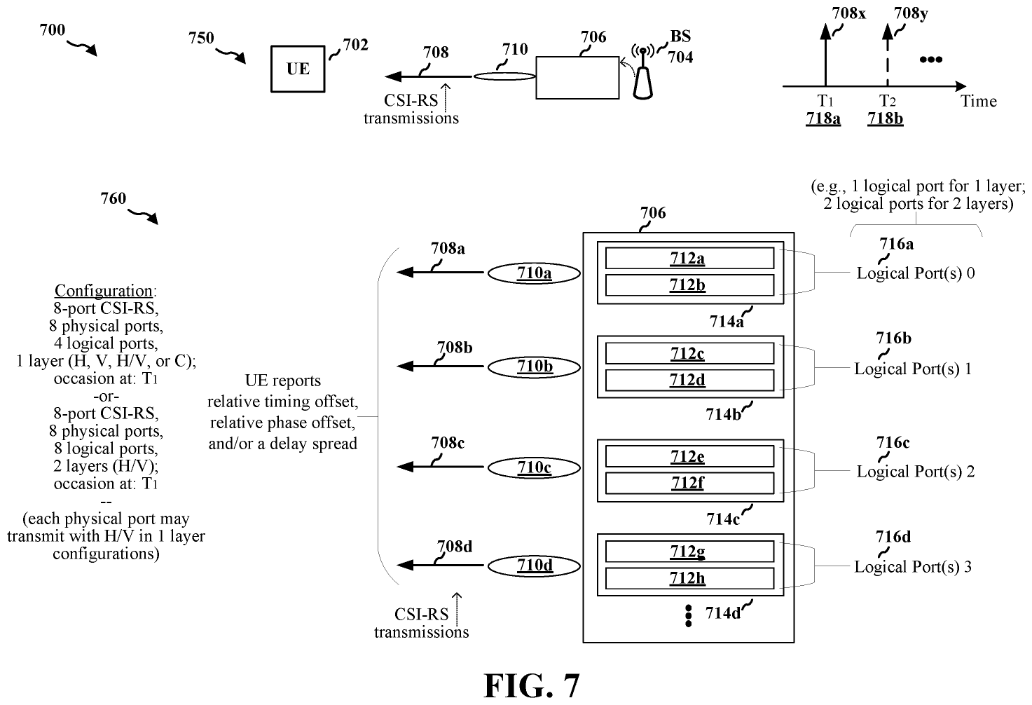

In the configuration 670, the UE 602 may be configured to transmit/provide, and the network node (e.g., the base station 604) may be configured to receive, uplink signaling 626. For example, the UE 602 may be configured to transmit/provide, and the network node (e.g., the base station 604) may be configured to receive, the CSI report(s) 610 that may include the default CSI metrics and/or the relative phase offset 616, as well as any number of other data, information, and/or metrics described above for the CSI report 610. In aspects, the uplink signaling 626 may be indicative of the relative timing offset 614 associated with the multiple CSI-RS transmissions (e.g., when not included in the CSI report(s) 610). In aspects, the uplink signaling 626 may include at least one of a sounding reference signal (SRS) or a PUSCH demodulation reference signal (DMRS). The network node (e.g., the base station 604) may be configure to calculate (at 628) the timing offset between the multiple antenna modules of the logically combined set of antenna modules based on the uplink signaling 626. FIG. 7 is a diagram 700 illustrating example aspects of independent sounding for two or more RF modules for increased EIRP, in various aspects. Diagram 700 shows a configuration 750 and a configuration 760 in the context of a UE 702 and a network node (e.g., a base station 704, a gNB, etc.).

In the configuration 750, the UE 702 may be configured to receive, and the network node (e.g., the base station 704) may be configured to transmit/provide, multiple CSI-RS transmissions 708, associated with a beams 710, which include a CSI-RS from each of logically combined sets of antenna modules 706 of the network node. In aspects, CSI-RS transmissions of the multiple CSI-RS transmissions 708 may be transmitted/provided at a first CSI-RS occasion 718a (e.g., at a time T₁) and/or at a second CSI-RS occasion 718b (e.g., at a time T₂). The CSI-RS occasion on which CSI-RS transmissions of the multiple CSI-RS transmissions 708 are transmitted/provided may be based on a number ‘M’ of CSI-RS ports configured at the UE 702 and a number ‘N’ of physical ports of the logically combined sets of antenna modules (e.g., having a number ‘N/2’ of logical ports and two layers). In some aspects, when the number ‘M’ of CSI-RS ports configured at the UE 702 is less than the number ‘N’ of physical ports of the logically combined sets of antenna modules (e.g., having a number ‘N/2’ of logical ports and two layers), first CSI-RS transmissions 708x of the multiple CSI-RS transmissions 708 may be transmitted/provided at the first CSI-RS occasion 718a at time T₁, and second CSI-RS transmissions 708y of the multiple CSI-RS transmissions 708 may be transmitted/provided at the second CSI-RS occasion 718b at time T₂. In some aspects, when the number ‘M’ of CSI-RS ports configured at the UE 702 is equal to the number ‘N’ of physical ports of the logically combined sets of antenna modules, the first CSI-RS transmissions 708x may be the multiple CSI-RS transmissions 708 and may be transmitted/provided at the first CSI-RS occasion 718a at time T₁. In other aspects, the second CSI-RS transmissions 708y of the multiple CSI-RS transmissions 708 may represent a next transmission/provision of the multiple CSI-RS transmissions 708 at the second CSI-RS occasion 718b at time T₂ for a subsequent iteration of independent sounding for two or more RF modules for increased EIRP described herein.

In aspects, a CSI report(s) may be based on at least four ports CSI-RS for the multiple CSI-RS transmissions, and one CSI-RS port of the at least four CSI-RS ports may be a measurement reference CSI-RS port. The UE 702 may be configured to measure at least one of a relative timing offset associated with a CSI-RS or a relative phase offset associated with a first CSI-RS and a second CSI-RS by measuring on each other CSI-RS port of the at least four CSI-RS ports than the one CSI-RS port of the at least four CSI-RS ports. In other words, in aspects where 1 CSI-RS port is a measurement reference CSI-RS port, the remaining M−1 CSI-RS ports may be utilized by the UE 702 for measurement of relative timing offsets/relative phase offsets.

The configuration 760 may be an aspect of the configuration 750 and illustrates extensibility to any number of logically combined set of antenna modules with a corresponding number of scaled CSI-RS ports. In some aspects, the base station 704 may configure a 2M-port CSI-RS, and expect a CSI report with M−1 relative timing/phase offsets, up to a maximum allowed number CSI-RS ports. In some aspects, the base station 704 may configure multiple instances of an M-port CSI-RS, where each instance may be transmitted/provided from a different pair of the logically combined set of antenna modules such that the UE 702 reports one timing/phase offset in each respective CSI report.

The configuration 760 illustrates an example configuration in which ‘M’ is 8 (e.g., 8-port CSI-RS is configured for the UE 702, or at least four ports in some aspects), ‘N’ is 8 (e.g., 8 physical ports may be configured at the base station 704, or at least four ports in some aspects), there may be 4 logical ports at the base station 704 with a single (one) layer (H, V, H/V, or circular (C) polarization) or 8 logical ports at the base station 704 with 2 layers (horizontal and vertical (H/V) polarization), and multiple CSI-RS transmissions may be transmitted/provided at the first CSI-RS occasion 718a at time T₁. That is, the logically combined sets of antenna modules 706 is shown, by way of example, as including a logically combined set of antenna modules 714a as a logical port(s) 716a (e.g., with an antenna module 712a and an antenna module 712b (e.g., as 1 logical port for single layer data or as 2 logical ports, e.g., 1 logical port per antenna module, for 2 layer data), and associated with a beam(s) 710a of beams 710 and a CSI-RS transmission(s) 708a of the multiple CSI-RS transmissions 708 (e.g., 1 beam and 1 CSI-RS transmission for single layer data or 2 beams and 2 CSI-RS transmissions for 2 layer data)), a logically combined set of antenna modules 714b as a logical port(s) 716b (e.g., with an antenna module 712c and an antenna module 712d (e.g., as 1 logical port for single layer data or as 2 logical ports, e.g., 1 logical port per antenna module, for 2 layer data), and associated with a beam(s) 710b of beams 710 and a CSI-RS transmission(s) 708b of the multiple CSI-RS transmissions 708 (e.g., 1 beam and 1 CSI-RS transmission for single layer data or 2 beams and 2 CSI-RS transmissions for 2 layer data)), a logically combined set of antenna modules 714c as a logical port(s) 716c (e.g., with an antenna module 712c and an antenna module 712f (e.g., as 1 logical port for single layer data or as 2 logical ports, e.g., 1 logical port per antenna module, for 2 layer data), and associated with a beam(s) 710c of beams 710 and a CSI-RS transmission(s) 708c of the multiple CSI-RS transmissions 708 (e.g., 1 beam and 1 CSI-RS transmission for single layer data or 2 beams and 2 CSI-RS transmissions for 2 layer data)), and a logically combined set of antenna modules 714d as a logical port(s) 716d (e.g., with an antenna module 712g and an antenna module 712h (e.g., as 1 logical port for single layer data or as 2 logical ports, e.g., 1 logical port per antenna module, for 2 layer data), and associated with a beam(s) 710d of beams 710 and a CSI-RS transmission(s) 708d of the multiple CSI-RS transmissions 708 (e.g., 1 beam and 1 CSI-RS transmission for single layer data or 2 beams and 2 CSI-RS transmissions for 2 layer data)). It is also contemplated for aspects that when there are two logical ports configured for 2 layers of data in a given logically combined set of antenna modules, from CSI-RS standpoint there may still be a single logical configuration per antenna module, and thus may be referred to as a logical CSI-RS configuration instead of a logical port.

In the context of the configuration 760, the UE 702 may be configured to generate and transmit/provide a CSI report that is configured for ‘M’ CSI-RS ports (e.g., in the illustrated aspect, ‘M’=8) and includes at least a relative timing offset, a relative phase offset, and/or a delay spread, based on the CSI-RS transmission(s) 708a, the CSI-RS transmission(s) 708b, the CSI-RS transmission(s) 708c, and the CSI-RS transmission(s) 708d all being transmitted/provided at the first CSI-RS occasion 718a at time T₁. Put another way, the UE 702 may be configured for an M-port CSI-RS, but the UE 702 is agnostic with respect to the behavior of the base station 704 and will base its CSI report on the CSI configuration. Thus, even when the base station 704 is configured with multiple instances of two ports (e.g., instances of two antennas as shown for the antenna modules in the configuration 760), the UE 702 operates according to its configuration for ‘M’ CSI-RS ports (e.g., 8 CSI-RS ports as shown by way of example in the illustrated aspect).

The base station 704 may be configured to interpret the CSI report information transmitted/provided by UE 702 associated with each logically combined set of antenna modules for two layer scheduling, and may be configured to interpret the reported quantities to the two layer case for different instances of the logically combined set of antenna modules to apply the precoding accordingly. In aspects, an additional CSI report metric(s) may also be defined to arrive at precoding coefficients to adjust phases per logically combined set of antenna modules to achieve an EIRP increase (e.g., a 3 dB gain). In aspects, the EIRP increase may be achieved when both phase and time delay per logically combined set of antenna modules are adjusted by the base station 704. The base station 704 may also be configure to advance or delay the signals from each logically combined set of antenna modules such that signaling from two or more of the logically combined set of antenna modules arrive at the UE 702 as “coherent in time.” While for a non-multipath case, such coherency may be achieved by factory calibration, in multiple path cases, various aspects may be implemented. In one example, a periodic CSI report from UE 702 may be utilized to adjust per UE 702 signaling from each of the logically combined set of antenna modules (which may be a complex task for frequency multiplexing UEs in a network node in the same transmission time interval (TTI) or symbols as each UE may experience different delays from different instances of the logically combined set of antenna modules. In another example, the base station 704 may be configured to perform UL measurements based on UL SRS or PUSCH DMRS, as described herein, and may be configured to report to its layer 2 for application of the same timing in DL signaling per logically combined set of antenna modules (e.g., using the parameter scrambling_init_len, which may be agnostic to UE behavior. If the base station 704 is configured to report TA, this may be extended to report in terms of sample per logically combined set of antenna modules to L2 from the base station 704, where based on the reported TA per logically combined set of antenna modules, L2 may instruct the base station 704 gNB L1 to apply the same timing for each logically combined set of antenna modules and each UE independently in downlink. In aspects, L2 may communicate per the logically combined set of antenna modules applied TA to the UE 702 utilizing a MAC-CE. Additionally, the base station 704 may vary the advance/delay from UE to UE.

It is also contemplated for aspects herein, e.g., in the context of the configuration 760, a UE such as the UE 702, may utilize a single layer (e.g., 1 layer) that is associated with horizontal, a CSI report(s) may be based on a single layer configuration and on at least four ports for multiple CSI-RS transmissions. In such configurations, the single layer may be associated with at least one of a vertical polarization, a horizontal polarization, or a circular polarization. That is, either of the vertical polarization, the horizontal polarization, or the circular polarization may be utilized, in aspects, while in other aspects, each configured antenna module may transmit utilizing the vertical polarization and the horizontal polarization.

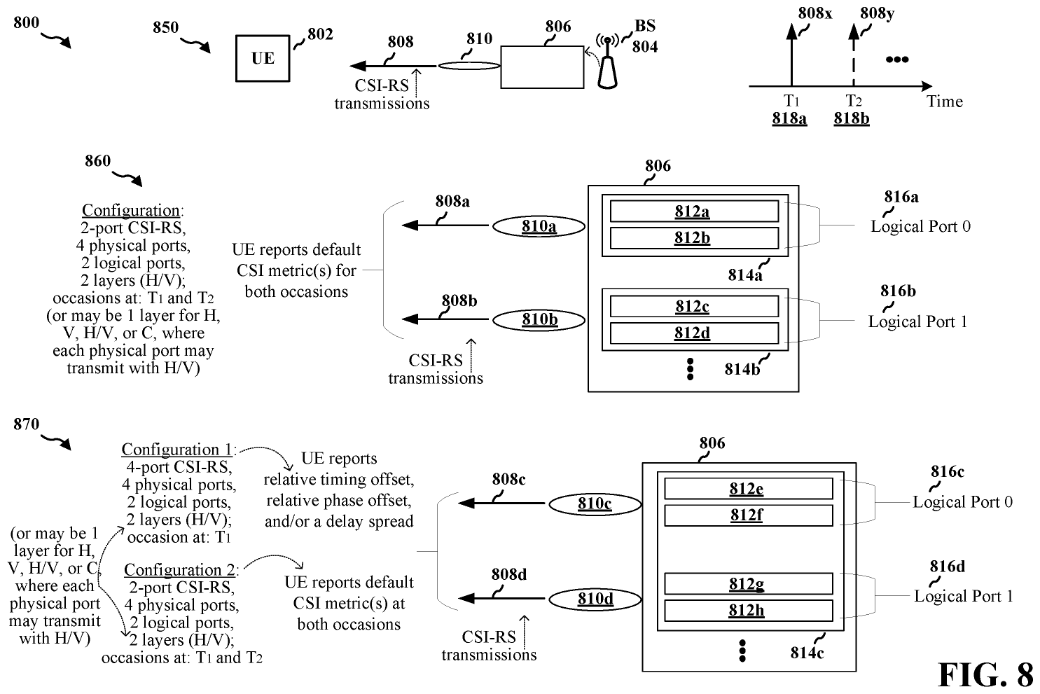

FIG. 8 is a diagram 800 illustrating example aspects of independent sounding for two or more RF modules for increased EIRP, in various aspects. Diagram 800 shows a configuration 850, a configuration 860, and a configuration 870 in the context of a UE 802 and a network node (e.g., a base station 804, a gNB, etc.).

In the configuration 850, the UE 802 may be configured to receive, and the network node (e.g., the base station 804) may be configured to transmit/provide, multiple CSI-RS transmissions 808, associated with a beams 810, which include a CSI-RS from each of logically combined sets of antenna modules 806 of the network node. In aspects, CSI-RS transmissions of the multiple CSI-RS transmissions 808 may be transmitted/provided at a first CSI-RS occasion 818a (e.g., at a time T₁) and/or at a second CSI-RS occasion 818b (e.g., at a time T₂). The CSI-RS occasion on which CSI-RS transmissions of the multiple CSI-RS transmissions 808 are transmitted/provided may be based on a number ‘M’ of CSI-RS ports configured at the UE 802 and a number ‘N’ of physical ports of the logically combined sets of antenna modules (e.g., having a number ‘N/2’ of logical ports and two layers). In some aspects, when the number ‘M’ of CSI-RS ports configured at the UE 802 is less than the number ‘N’ of physical ports of the logically combined sets of antenna modules (e.g., having a number ‘N/2’ of logical ports and two layers), first CSI-RS transmissions 808x of the multiple CSI-RS transmissions 808 may be transmitted/provided at the first CSI-RS occasion 818a at time T₁, and second CSI-RS transmissions 808y of the multiple CSI-RS transmissions 808 may be transmitted/provided at the second CSI-RS occasion 818b at time T₂. In some aspects, when the number ‘M’ of CSI-RS ports configured at the UE 802 is equal to the number ‘N’ of physical ports of the logically combined sets of antenna modules, the first CSI-RS transmissions 808x may be the multiple CSI-RS transmissions 808 and may be transmitted/provided at the first CSI-RS occasion 818a at time T₁. In other aspects, the second CSI-RS transmissions 808y of the multiple CSI-RS transmissions 808 may represent a next transmission/provision of the multiple CSI-RS transmissions 808 at the second CSI-RS occasion 818b at time T₂ for a subsequent iteration of independent sounding for two or more RF modules for increased EIRP described herein.

The configuration 860 may be an aspect of the configuration 850 and illustrates extensibility to any number of logically combined set of antenna modules with a given number of CSI-RS ports. In some aspects, the base station 804 may configure a 1-port CSI-RS for each logically combined set of antenna modules, and expect a CSI report with a timing/phase offset with each CSI report. In some aspects, the base station 804 may configure N instances of the logically combined set of antenna modules where timing/phase offsets may be measured pair-wise. In some aspects, the base station 804 may configure multiple antennas of the same logically combined set of antenna modules where timing/phase offsets may be measured between pairs of antenna ports. In some of such aspects, the base station 804 may transmit/provide multiple instances of M-port CSI-RS from different pairs of antenna ports, and each CSI report may include a relative timing/phase offset between the two antenna ports of the given pairs, respectively.

The configuration 860 illustrates an example configuration in which ‘M’ is 2 (e.g., 2-port CSI-RS is configured for the UE 802), ‘N’ is 4 (e.g., 4 physical ports are configured at the base station 804), there are 2 logical ports at the base station 804 with 2 layers (H/V), and multiple CSI-RS transmissions are transmitted/provided at the first CSI-RS occasion 818a at time T₁ and at the second CSI-RS occasion 818b at time T₂. That is, the logically combined sets of antenna modules 806 is shown, by way of example, as including a logically combined set of antenna modules 814a as a logical port 816a (e.g., with an antenna module 812a and an antenna module 812b, and associated with a beam 810a of beams 810 and a CSI-RS transmission 808a of the multiple CSI-RS transmissions 808), and a logically combined set of antenna modules 814b as a logical port 816b (e.g., with an antenna module 812c and an antenna module 812d, and associated with a beam 810b of beams 810 and a CSI-RS transmission 808b of the multiple CSI-RS transmissions 808).

Accordingly, the base station 804 may configure two instances of the logically combined set of antenna modules and utilize a 2-Port CSI-RS from a single instance at a time. In this case, the base station 804 may be configured to schedule two ports of CSI-RS on the first instance of the logically combined set of antenna modules 814a or two ports of CSI-RS on the second instance of the logically combined set of antenna modules 814b. From the UE 802 perspective, this is seen as 2-port CSI-RS, and the UE 802 may be configured transmit/provide back a CSI report, assuming the UE 802 has 2-port CSI-RS information. base station 804 may be configured to receive the 2-port CSI report provided by UE 802 and beamform both the first instance of the logically combined set of antenna modules 814a and the second instance of the logically combined set of antenna modules 814b jointly. In aspects, calibration may accomplish the first instance of the logically combined set of antenna modules 814a-to-the second instance of the logically combined set of antenna modules 814b time alignment error, and the beamforming may be modeled for both the first instance of the logically combined set of antenna modules 814a and the second instance of the logically combined set of antenna modules 814b combined. In such aspects, no CSI reporting or other change is made from the UE 802 side, and the UE 802 may be configured to report default CSI metrics (e.g., for the first CSI-RS occasion 818a (time T₁) and the second CSI-RS occasion 818b (time T₂)).

The configuration 870 illustrates an example scenario in which at least two ports are associated with different pairs of antennas included in the same antenna module, and has two potential sub-configurations: a configuration 1 and a configuration 2. In the configuration 1, ‘M’ is 4 (e.g., 4-port CSI-RS is configured for the UE 802, or at least four ports in some aspects), ‘N’ is 4 (e.g., 4 physical ports are configured at the base station 804), there are 2 logical ports at the base station 804 with 2 layers (H/V), and multiple CSI-RS transmissions are transmitted/provided at the first CSI-RS occasion 818a at time T₁. In the configuration 1, ‘M’ is 2 (e.g., 2-port CSI-RS is configured for the UE 802), ‘N’ is 4 (e.g., 4 physical ports are configured at the base station 804), there are 2 logical ports at the base station 804 with 2 layers (H/V), and multiple CSI-RS transmissions are transmitted/provided at the first CSI-RS occasion 818a at time T₁ and at the second CSI-RS occasion 818b at time T₂. That is, the logically combined sets of antenna modules 806 is shown, by way of example, as including a logically combined set of antenna modules 814c as a logical port 816c (e.g., with an antenna module 812e and an antenna module 812f, and associated with a beam 810c of beams 810 and a CSI-RS transmission 808c of the multiple CSI-RS transmissions 808) and a logical port 816d (e.g., with an antenna module 812g and an antenna module 812h, and associated with a beam 810d of beams 810 and a CSI-RS transmission 808d of the multiple CSI-RS transmissions 808). The measured timing/phase offsets may be utilized for compensation of timing/phase differences between antenna ports/modules at the base station 804 so that the signals from all or selected antenna ports/modules are combined in a coherent manner at or near the UE 802. The base station 804 may be configured to calculate a relative offset of the time and/or phase metrics between the antenna modules/ports and apply a corresponding offset(s) accordingly to make signals appear in-phase and coherent at the UE 802 to achieve the EIRP gain. Thus, for the configuration 1, the UE 802 may be configured to generate and transmit/provide a CSI report that is configured for ‘M’ CSI-RS ports (e.g., in the illustrated aspect, ‘M’=4) and includes at least a relative timing offset, a relative phase offset, and/or a delay spread, based on the CSI-RS transmission 808a and the CSI-RS transmission 808b both being transmitted/provided at the first CSI-RS occasion 818a at time T₁. Put another way, the UE 802 may be configured for an M-port CSI-RS, but the UE 802 is agnostic with respect to the behavior of the base station 804 and will base its CSI report on the CSI configuration. Thus, even when the base station 804 is configured with multiple instances of two ports (e.g., instances of two antennas as shown for the antenna modules in the configuration 870 (configuration 1)), the UE 802 operates according to its configuration for ‘M’ CSI-RS ports (e.g., 4 CSI-RS ports as shown by way of example in the illustrated aspect).

The base station 804 may be configured to interpret the CSI report information transmitted/provided by UE 802 associated with each instance of antenna pairs for two layer scheduling, and may be configured to interpret the reported quantities to the two layer case for different instances of the antenna pairs to apply the precoding accordingly. In aspects, an additional CSI report metric(s) may also be defined to arrive at precoding coefficients to adjust phases per antenna pair to achieve an EIRP increase (e.g., a 3 dB gain).

However, for the configuration 2, the base station 804 may configure one instance of the logically combined set of antenna modules and utilize a 2-Port CSI-RS from pairs of antenna modules thereof at a time. In this case, the base station 804 may be configured to schedule two ports of CSI-RS on the antenna module 812e and the antenna module 812f or two ports of CSI-RS on the antenna module 812g and the antenna module 812h. From the UE 802 perspective, this is seen as 2-port CSI-RS, and the UE 802 may be configured transmit/provide back a CSI report, assuming the UE 802 has 2-port CSI-RS information. base station 804 may be configured to receive the 2-port CSI report provided by UE 802 and beamform both the antenna module 812e and the antenna module 812f, and the antenna module 812g and the antenna module 812h, jointly. In aspects, calibration may accomplish the antenna pair-to-antenna pair time alignment error, and the beamforming may be modeled for both of than antenna pairs combined to achieve an EIRP increase. In such aspects, no CSI reporting or other change is made from the UE 802 side, and the UE 802 may be configured to report default CSI metrics (e.g., for the first CSI-RS occasion 818a (time T₁) and the second CSI-RS occasion 818b (time T₂)).

It is also contemplated for aspects herein, e.g., in the context of the configuration 860 and/or the configuration 870, a UE such as the UE 802, may utilize a single layer (e.g., 1 layer) that is associated with horizontal, a CSI report(s) may be based on a single layer configuration and on at least four ports for multiple CSI-RS transmissions. In such configurations, the single layer may be associated with at least one of a vertical polarization, a horizontal polarization, or a circular polarization. That is, either of the vertical polarization, the horizontal polarization, or the circular polarization may be utilized, in aspects, while in other aspects, each configured antenna module may transmit utilizing the vertical polarization and the horizontal polarization.

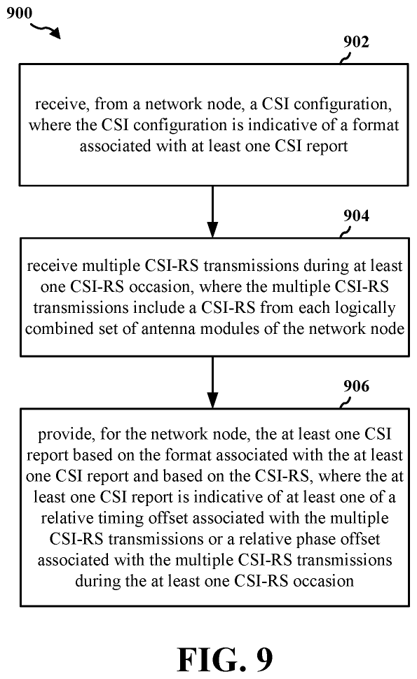

FIG. 9 is a flowchart 900 of a method of wireless communication, in various aspects. The method may be performed by a UE (e.g., the UE 104, 502, 602, 702, 802; the apparatus 1104). In some aspects, the method may include aspects described in connection with the communication flow in FIG. 5 and/or aspects described in FIGS. 6, 7, 8. The method may be for independent sounding for two or more RF modules for increased EIRP and may enable a UE to receive CSI-RS transmissions and provide indicia to a network node of relative CSI-RS timing/phase offsets associated with its logically combined sets of antenna modules such that the network node may implement timing/phase offsets therefor, and notify the UE thereof, to allow coherent combinations of beams received at the UE and increase EIRP.

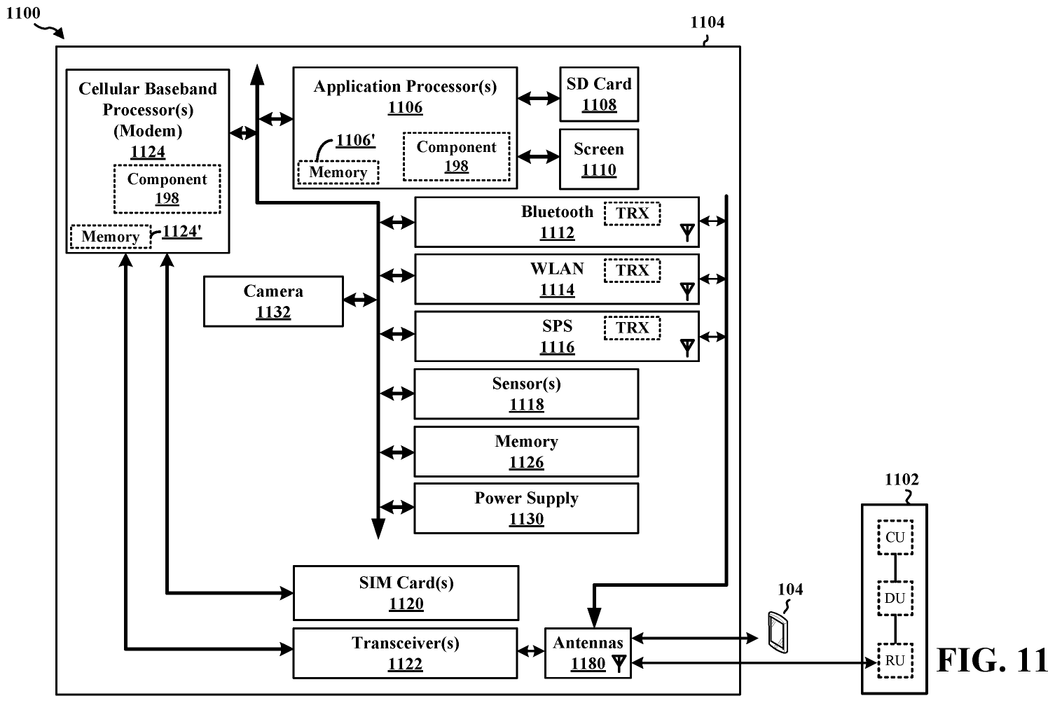

At 902, the UE receives, from a network node, a CSI configuration, where the CSI configuration is indicative of a format associated with at least one CSI report. As an example, the reception may be performed by one or more of the component 198, the transceiver 1122, and/or the antenna 1180 in FIG. 11. FIG. 5, in the context of FIGS. 6, 7, 8, illustrates an example of the UE 502 receiving such a CSI configuration from a network node (e.g., the base station 504).

The UE 502 may be configured to receive, and a network node (e.g., the base station 504) may be configured to transmit/provide, a CSI configuration 506 (e.g., 606 in FIG. 6). The CSI configuration 506 (e.g., 606 in FIG. 6) may be indicative of a format associated with at least one CSI report 512 (e.g., 610, 610′ in FIG. 6). As an example, the CSI configuration 506 (e.g., 606 in FIG. 6) may indicate to, or configure, the UE 502 for a number ‘M’ of CSI-RS ports (e.g., 608 in FIG. 6), types of metrics (e.g., 612, 614, 616, 617, 618, 619, 620 in FIG. 6) to be included in the at least one CSI report 512 (e.g., 610, 610′ in FIG. 6) per the format, a periodicity for transmitting/providing the at least one CSI report 512 (e.g., 610, 610′ in FIG. 6), and/or the like. At 904, the UE receives multiple CSI-RS transmissions during at least one CSI-RS occasion, where the multiple CSI-RS transmissions include a CSI-RS from each logically combined set of antenna modules of the network node. As an example, the reception may be performed by one or more of the component 198, the transceiver 1122, and/or the antenna 1180 in FIG. 11. FIG. 5, in the context of FIGS. 6, 7, 8, illustrates an example of the UE 502 receiving such a CSI-RS transmissions during at least one CSI-RS occasion from a network node (e.g., the base station 504).

The UE 502 may be configured to receive, and a network node (e.g., the base station 504) may be configured to transmit/provide, multiple CSI-RS transmissions 508 (e.g., 708, 708a-708d, 708x, 708y in FIG. 7; 808, 808a-808d, 808x, 808y in FIG. 8) during at least one CSI-RS occasion (e.g., 718a, 718b in FIG. 7; 818a, 818b in FIG. 8). The multiple CSI-RS transmissions 508 (e.g., 708, 708a-708d, 708x, 708y in FIG. 7; 808, 808a-808d, 808x, 808y in FIG. 8) may include a CSI-RS from each logically combined set of antenna modules (e.g., 706, 714a-714d in FIG. 7; 806, 814a-814c in FIG. 8) of the network node. In aspects, CSI-RS transmissions of the multiple CSI-RS transmissions 508 (e.g., 708, 708a-708d, 708x, 708y in FIG. 7; 808, 808a-808d, 808x, 808y in FIG. 8) may be transmitted/provided at a first CSI-RS occasion (e.g., at a time T₁) (e.g., 718a in FIG. 7; 818a in FIG. 8) and/or at a second CSI-RS occasion (e.g., at a time T₂) (e.g., 718b in FIG. 7; 818b in FIG. 8), and may be associated with respective beams (e.g., 710, 710a-710d in FIG. 7; 810, 810a-810d in FIG. 8). The CSI-RS occasion (e.g., 718a, 718b in FIG. 7; 818a, 818b in FIG. 8) on which CSI-RS transmissions of the multiple CSI-RS transmissions 508 (e.g., 708, 708a-708d, 708x, 708y in FIG. 7; 808, 808a-808d, 808x, 808y in FIG. 8) are transmitted/provided may be based on a number ‘M’ of CSI-RS ports (e.g., 608 in FIG. 6) configured at the UE 502 and a number ‘N’ of physical ports (e.g., 712a-712h in FIG. 7; 812a-812h in FIG. 8) of the logically combined sets of antenna modules (e.g., 706, 714a-714d in FIG. 7; 806, 814a-814c in FIG. 8) (e.g., having a number ‘N/2’ of logical ports (e.g., 716a-716d in FIG. 7; 816a-816d in FIG. 8) and two layers (e.g., 607 (H/V) in FIG. 6) at the base station 504. In some aspects, when the number ‘M’ of CSI-RS ports (e.g., 608 in FIG. 6) configured at the UE 502 is less than the number ‘N’ of physical ports (e.g., 712a-712h in FIG. 7; 812a-812h in FIG. 8) of the logically combined sets of antenna modules (e.g., 706, 714a-714d in FIG. 7; 806, 814a-814c in FIG. 8) (e.g., having a number ‘N/2’ of logical ports (e.g., 716a-716h in FIG. 7; 816a-816h in FIG. 8) and two layers (e.g., 607 (H/V) in FIG. 6)) at the base station 504, first CSI-RS transmissions of the multiple CSI-RS transmissions 508 (e.g., 708, 708a-708d, 708x, 708y in FIG. 7; 808, 808a-808d, 808x, 808y in FIG. 8) may be transmitted/provided at the first CSI-RS occasion (e.g., 718a in FIG. 7; 818a in FIG. 8) at time T₁, and second CSI-RS transmissions of the multiple CSI-RS transmissions 508 (e.g., 708, 708a-708d, 708x, 708y in FIG. 7; 808, 808a-808d, 808x, 808y in FIG. 8) may be transmitted/provided at the second CSI-RS occasion (e.g., 718b in FIG. 7; 818b in FIG. 8) at time T₂. In some aspects, when the number ‘M’ of CSI-RS ports (e.g., 608 in FIG. 6) configured at the UE 502 is equal to the number ‘N’ of physical ports (e.g., 712a-712h in FIG. 7; 812a-812h in FIG. 8) of the logically combined sets of antenna modules (e.g., 706, 714a-714d in FIG. 7; 806, 814a-814c in FIG. 8) at the base station 504, the multiple CSI-RS transmissions 508 (e.g., 708, 708a-708d, 708x, 708y in FIG. 7; 808, 808a-808d, 808x, 808y in FIG. 8) may be transmitted/provided at the first CSI-RS occasion (e.g., 718a in FIG. 7; 818a in FIG. 8) at time T₁.

At 906, the UE provides, for the network node, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion. As an example, the provision/transmission may be performed by one or more of the component 198, the transceiver 1122, and/or the antenna 1180 in FIG. 11. FIG. 5, in the context of FIGS. 6, 7, 8, illustrates an example of the UE 502 providing/transmitting such a CSI report(s) for a network node (e.g., the base station 504).

The UE 502 may be configured to transmit/provide, and the network node (e.g., the base station 504) may be configured to receive, the at least one CSI report 512 (e.g., 610, 610′ in FIG. 6) based on the format associated with the at least one CSI report 512 (e.g., 610, 610′ in FIG. 6) and based on the CSI-RS. The at least one CSI report 512 (e.g., 610, 610′ in FIG. 6) may be indicative of at least one of a relative timing offset (e.g., 614 in FIG. 6) associated with the multiple CSI-RS transmissions 508 (e.g., 708, 708a-708d, 708x, 708y in FIG. 7; 808, 808a-808d, 808x, 808y in FIG. 8) or a relative phase offset (e.g., 616 in FIG. 6) associated with the multiple CSI-RS transmissions 508 (e.g., 708, 708a-708d, 708x, 708y in FIG. 7; 808, 808a-808d, 808x, 808y in FIG. 8) during the at least one CSI-RS occasion (e.g., 718a, 718b in FIG. 7; 818a, 818b in FIG. 8). In aspects, at least one CSI report 512 (e.g., 610, 610′ in FIG. 6) may be indicative of a relative timing offset (e.g., 614 in FIG. 6) and/or a relative phase offset (e.g., 616 in FIG. 6) associated with the multiple CSI-RS transmissions 508 (e.g., 708, 708a-708d, 708x, 708y in FIG. 7; 808, 808a-808d, 808x, 808y in FIG. 8) during the CSI-RS occasion(s) (e.g., 718a, 718b in FIG. 7; 818a, 818b in FIG. 8). In aspects, the at least one CSI report 512 (e.g., 610, 610′ in FIG. 6) may indicate the relative timing offset (e.g., 614 in FIG. 6), the relative phase offset (e.g., 616 in FIG. 6), and/or the delay spread (e.g., 618 in FIG. 6).

The network node (e.g., the base station 504) may be configured to calculate (at 514) (e.g., at 628 in FIG. 6) at least one of a timing offset (e.g., 624 in FIG. 6), a phase offset (e.g., 624 in FIG. 6), or a delay spread between multiple antenna modules (e.g., 712a-712h in FIG. 7; 812a-812h in FIG. 8) of a logically combined set of antenna modules (e.g., 706, 714a-714d in FIG. 7; 806, 814a-814c in FIG. 8) based on the at least one CSI report 512 (e.g., 610, 610′ in FIG. 6). In one example, the at least one CSI report 512 (e.g., 610, 610′ in FIG. 6) may be more than one CSI report (e.g., 610, 610′ in FIG. 6), such as when a number of CSI-RS ports (e.g., 608 in FIG. 6) configured at the UE 502 is less than a number of physical ports (e.g., 712a-712h in FIG. 7; 812a-812h in FIG. 8) of the logically combined sets of antenna modules (e.g., 706, 714a-714d in FIG. 7; 806, 814a-814c in FIG. 8), which provides indicia of the relative timing offset (e.g., 614 in FIG. 6) and/or the relative phase offset (e.g., 616 in FIG. 6), and the network node (e.g., the base station 504) may calculate (at 514) (e.g., at 628 in FIG. 6) a timing offset and/or a phase offset (e.g., 624 in FIG. 6) of its antenna modules (e.g., 712a-712h in FIG. 7; 812a-812h in FIG. 8) and provide the UE 502 with an indication (e.g., 624 in FIG. 6) thereof. In one example, the at least one CSI report 512 (e.g., 610, 610′ in FIG. 6) may be one CSI report (e.g., 610 in FIG. 6), such as when the number of CSI-RS ports (e.g., 608 in FIG. 6) configured at the UE 502 is equal to the number of physical ports (e.g., 712a-712h in FIG. 7; 812a-812h in FIG. 8), which provides the relative timing offset (e.g., 614 in FIG. 6) and/or the relative phase offset (e.g., 616 in FIG. 6) measured by the UE 502, and the network node (e.g., the base station 504) may calculate (at 514) (e.g., at 628 in FIG. 6) a timing offset and/or a phase offset (e.g., 624 in FIG. 6) of its antenna modules (e.g., 712a-712h in FIG. 7; 812a-812h in FIG. 8) and provide the UE 502 with an indication (e.g., 624 in FIG. 6) thereof.

The UE 502 may be configured to receive, and a network node (e.g., the base station 504) may be configured to transmit/provide, a PDSCH (e.g., 622 in FIG. 6) from the logically combined set of antenna modules (e.g., 706, 714a-714d in FIG. 7; 806, 814a-814c in FIG. 8). In aspects, at least one of the timing offset or the phase offset (e.g., 624 in FIG. 6) between the multiple antenna modules (e.g., 712a-712h in FIG. 7; 812a-812h in FIG. 8) of the logically combined set of antenna modules (e.g., 706, 714a-714d in FIG. 7; 806, 814a-814c in FIG. 8) may be based on the at least one CSI report 512 (e.g., 610, 610′ in FIG. 6). The UE 502 may be configured to receive, and a network node (e.g., the base station 504) may be configured to transmit/provide, an indication (e.g., 624 in FIG. 6) of the at least one of the timing offset or the phase offset (e.g., 624 in FIG. 6).

As the CSI-RS channel is common for multiple UEs in a wideband allocation for a network node (e.g., a base station, gNB, etc.), correction applied by the network node to dedicated configurations (e.g., PDSCH (e.g., 622 in FIG. 6)) for a UE, per its CSI report (e.g., 610, 610′ in FIG. 6), may also be communicated back to the UE itself. In this way, the UE is enabled to understand or be aware of how much delta is applied to its dedicated data with respect to the CSI-RS. Accordingly, aspects may provide for the indication (e.g., 624 in FIG. 6) of such information of time difference applied per TRP as a MAC-CE in PDSCH (e.g., 622 in FIG. 6) data. The value in the MAC-CE may point to a table which may indicate a delta applied to one TRP with respect to another TRP, and may be extended to multi-TRP systems.

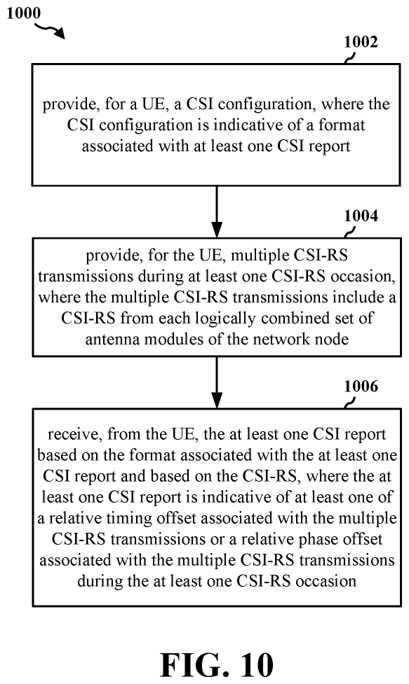

FIG. 10 is a flowchart 1000 of a method of wireless communication, in various aspects. The method may be performed by a network node, such as a base station, gNB, etc. (e.g., the base station 102, 504, 604, 704, 804; the network entity 1102, 1202). In some aspects, the method may include aspects described in connection with the communication flow in FIG. 5 and/or aspects described in FIGS. 6, 7, 8. The method may be for independent sounding for two or more RF modules for increased EIRP and may enable a UE to receive CSI-RS transmissions and provide indicia to a network node of relative CSI-RS timing/phase offsets associated with its logically combined sets of antenna modules such that the network node may implement timing/phase offsets therefor, and notify the UE thereof, to allow coherent combinations of beams received at the UE and increase EIRP.

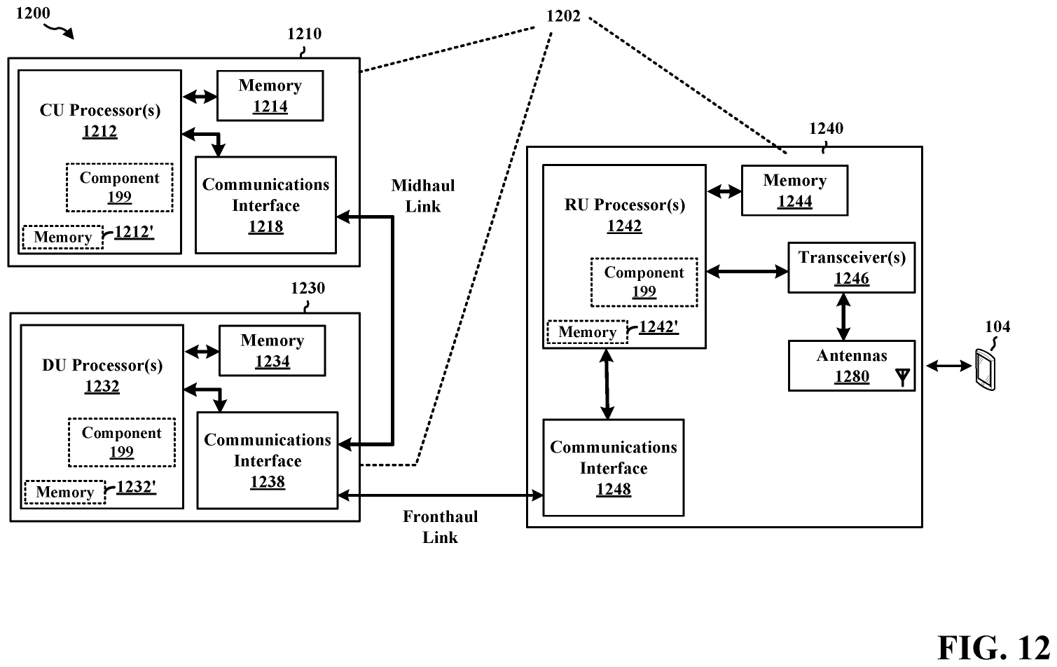

At 1002, the network node provides, for a UE, a CSI configuration, where the CSI configuration is indicative of a format associated with at least one CSI report. As an example, the provision/transmission may be performed by one or more of the component 199, the transceiver 1246, and/or the antenna 1280 in FIG. 12. FIG. 5, in the context of FIGS. 6, 7, 8, illustrates an example of a network node (e.g., the base station 504) providing/transmitting such a CSI configuration for a UE (e.g., the UE 502).

The network node (e.g., the base station 504) may be configured to transmit/provide, and the UE 502 may be configured to receive, a CSI configuration 506 (e.g., 606 in FIG. 6). The CSI configuration 506 (e.g., 606 in FIG. 6) may be indicative of a format associated with at least one CSI report 512 (e.g., 610, 610′ in FIG. 6). As an example, the CSI configuration 506 (e.g., 606 in FIG. 6) may indicate to, or configure, the UE 502 for a number ‘M’ of CSI-RS ports (e.g., 608 in FIG. 6), types of metrics (e.g., 612, 614, 616, 617, 618, 619, 620 in FIG. 6) to be included in the at least one CSI report 512 (e.g., 610, 610′ in FIG. 6) per the format, a periodicity for transmitting/providing the at least one CSI report 512 (e.g., 610, 610′ in FIG. 6), and/or the like.

At 1004, the network node provides, for the UE, multiple CSI-RS transmissions during at least one CSI-RS occasion, where the multiple CSI-RS transmissions include a CSI-RS from each logically combined set of antenna modules of the network node. As an example, the provision/transmission may be performed by one or more of the component 199, the transceiver 1246, and/or the antenna 1280 in FIG. 12. FIG. 5, in the context of FIGS. 6, 7, 8, illustrates an example of a network node (e.g., the base station 504) providing/transmitting such CSI-RS transmissions during at least one CSI-RS occasion for a UE (e.g., the UE 502).

The network node (e.g., the base station 504) may be configured to transmit/provide, and the UE 502 may be configured to receive, multiple CSI-RS transmissions 508 (e.g., 708, 708a-708d, 708x, 708y in FIG. 7; 808, 808a-808d, 808x, 808y in FIG. 8) during at least one CSI-RS occasion (e.g., 718a, 718b in FIG. 7; 818a, 818b in FIG. 8). The multiple CSI-RS transmissions 508 (e.g., 708, 708a-708d, 708x, 708y in FIG. 7; 808, 808a-808d, 808x, 808y in FIG. 8) may include a CSI-RS from each logically combined set of antenna modules (e.g., 706, 714a-714d in FIG. 7; 806, 814a-814c in FIG. 8) of the network node. In aspects, CSI-RS transmissions of the multiple CSI-RS transmissions 508 (e.g., 708, 708a-708d, 708x, 708y in FIG. 7; 808, 808a-808d, 808x, 808y in FIG. 8) may be transmitted/provided at a first CSI-RS occasion (e.g., at a time T₁) (e.g., 718a in FIG. 7; 818a in FIG. 8) and/or at a second CSI-RS occasion (e.g., at a time T₂) (e.g., 718b in FIG. 7; 818b in FIG. 8), and may be associated with respective beams (e.g., 710, 710a-710d in FIG. 7; 810, 810a-810d in FIG. 8). The CSI-RS occasion (e.g., 718a, 718b in FIG. 7; 818a, 818b in FIG. 8) on which CSI-RS transmissions of the multiple CSI-RS transmissions 508 (e.g., 708, 708a-708d, 708x, 708y in FIG. 7; 808, 808a-808d, 808x, 808y in FIG. 8) are transmitted/provided may be based on a number ‘M’ of CSI-RS ports (e.g., 608 in FIG. 6) configured at the UE 502 and a number ‘N’ of physical ports (e.g., 712a-712h in FIG. 7; 812a-812h in FIG. 8) of the logically combined sets of antenna modules (e.g., 706, 714a-714d in FIG. 7; 806, 814a-814c in FIG. 8) (e.g., having a number ‘N/2’ of logical ports (e.g., 716a-716d in FIG. 7; 816a-816d in FIG. 8) and two layers (e.g., 607 (H/V) in FIG. 6) at the base station 504. In some aspects, when the number ‘M’ of CSI-RS ports (e.g., 608 in FIG. 6) configured at the UE 502 is less than the number ‘N’ of physical ports (e.g., 712a-712h in FIG. 7; 812a-812h in FIG. 8) of the logically combined sets of antenna modules (e.g., 706, 714a-714d in FIG. 7; 806, 814a-814c in FIG. 8) (e.g., having a number ‘N/2’ of logical ports (e.g., 716a-716h in FIG. 7; 816a-816h in FIG. 8) and two layers (e.g., 607 (H/V) in FIG. 6)) at the base station 504, first CSI-RS transmissions of the multiple CSI-RS transmissions 508 (e.g., 708, 708a-708d, 708x, 708y in FIG. 7; 808, 808a-808d, 808x, 808y in FIG. 8) may be transmitted/provided at the first CSI-RS occasion (e.g., 718a in FIG. 7; 818a in FIG. 8) at time T₁, and second CSI-RS transmissions of the multiple CSI-RS transmissions 508 (e.g., 708, 708a-708d, 708x, 708y in FIG. 7; 808, 808a-808d, 808x, 808y in FIG. 8) may be transmitted/provided at the second CSI-RS occasion (e.g., 718b in FIG. 7; 818b in FIG. 8) at time T₂. In some aspects, when the number ‘M’ of CSI-RS ports (e.g., 608 in FIG. 6) configured at the UE 502 is equal to the number ‘N’ of physical ports (e.g., 712a-712h in FIG. 7; 812a-812h in FIG. 8) of the logically combined sets of antenna modules (e.g., 706, 714a-714d in FIG. 7; 806, 814a-814c in FIG. 8) at the base station 504, the multiple CSI-RS transmissions 508 (e.g., 708, 708a-708d, 708x, 708y in FIG. 7; 808, 808a-808d, 808x, 808y in FIG. 8) may be transmitted/provided at the first CSI-RS occasion (e.g., 718a in FIG. 7; 818a in FIG. 8) at time T₁.

At 1006, the network node receives, from the UE, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion. As an example, the reception may be performed by one or more of the component 199, the transceiver 1246, and/or the antenna 1280 in FIG. 12. FIG. 5, in the context of FIGS. 6, 7, 8, illustrates an example of a network node (e.g., the base station 504) receiving such a CSI report(s) from a UE (e.g., the UE 502).

The network node (e.g., the base station 504) may be configured to receive, and the UE 502 may be configured to transmit/provide, the at least one CSI report 512 (e.g., 610, 610′ in FIG. 6) based on the format associated with the at least one CSI report 512 (e.g., 610, 610′ in FIG. 6) and based on the CSI-RS. The at least one CSI report 512 (e.g., 610, 610′ in FIG. 6) may be indicative of at least one of a relative timing offset (e.g., 614 in FIG. 6) associated with the multiple CSI-RS transmissions 508 (e.g., 708, 708a-708d, 708x, 708y in FIG. 7; 808, 808a-808d, 808x, 808y in FIG. 8) or a relative phase offset (e.g., 616 in FIG. 6) associated with the multiple CSI-RS transmissions 508 (e.g., 708, 708a-708d, 708x, 708y in FIG. 7; 808, 808a-808d, 808x, 808y in FIG. 8) during the at least one CSI-RS occasion (e.g., 718a, 718b in FIG. 7; 818a, 818b in FIG. 8). In aspects, at least one CSI report 512 (e.g., 610, 610′ in FIG. 6) may be indicative of a relative timing offset (e.g., 614 in FIG. 6) and/or a relative phase offset (e.g., 616 in FIG. 6) associated with the multiple CSI-RS transmissions 508 (e.g., 708, 708a-708d, 708x, 708y in FIG. 7; 808, 808a-808d, 808x, 808y in FIG. 8) during the CSI-RS occasion(s) (e.g., 718a, 718b in FIG. 7; 818a, 818b in FIG. 8). In aspects, the at least one CSI report 512 (e.g., 610, 610′ in FIG. 6) may indicate the relative timing offset (e.g., 614 in FIG. 6), the relative phase offset (e.g., 616 in FIG. 6), and/or the delay spread (e.g., 618 in FIG. 6).

The network node (e.g., the base station 504) may be configured to calculate (at 514) (e.g., at 628 in FIG. 6) at least one of a timing offset (e.g., 624 in FIG. 6), a phase offset (e.g., 624 in FIG. 6), or a delay spread between multiple antenna modules (e.g., 712a-712h in FIG. 7; 812a-812h in FIG. 8) of a logically combined set of antenna modules (e.g., 706, 714a-714d in FIG. 7; 806, 814a-814c in FIG. 8) based on the at least one CSI report 512 (e.g., 610, 610′ in FIG. 6). In one example, the at least one CSI report 512 (e.g., 610, 610′ in FIG. 6) may be more than one CSI report (e.g., 610, 610′ in FIG. 6), such as when a number of CSI-RS ports (e.g., 608 in FIG. 6) configured at the UE 502 is less than a number of physical ports (e.g., 712a-712h in FIG. 7; 812a-812h in FIG. 8) of the logically combined sets of antenna modules (e.g., 706, 714a-714d in FIG. 7; 806, 814a-814c in FIG. 8), which provides indicia of the relative timing offset (e.g., 614 in FIG. 6) and/or the relative phase offset (e.g., 616 in FIG. 6), and the network node (e.g., the base station 504) may calculate (at 514) (e.g., at 628 in FIG. 6) a timing offset and/or a phase offset (e.g., 624 in FIG. 6) of its antenna modules (e.g., 712a-712h in FIG. 7; 812a-812h in FIG. 8) and provide the UE 502 with an indication (e.g., 624 in FIG. 6) thereof. In one example, the at least one CSI report 512 (e.g., 610, 610′ in FIG. 6) may be one CSI report (e.g., 610 in FIG. 6), such as when the number of CSI-RS ports (e.g., 608 in FIG. 6) configured at the UE 502 is equal to the number of physical ports (e.g., 712a-712h in FIG. 7; 812a-812h in FIG. 8), which provides the relative timing offset (e.g., 614 in FIG. 6) and/or the relative phase offset (e.g., 616 in FIG. 6) measured by the UE 502, and the network node (e.g., the base station 504) may calculate (at 514) (e.g., at 628 in FIG. 6) a timing offset and/or a phase offset (e.g., 624 in FIG. 6) of its antenna modules (e.g., 712a-712h in FIG. 7; 812a-812h in FIG. 8) and provide the UE 502 with an indication (e.g., 624 in FIG. 6) thereof.

The network node (e.g., the base station 504) may be configured to transmit/provide, and the UE 502 may be configured to receive, a PDSCH (e.g., 622 in FIG. 6) from the logically combined set of antenna modules (e.g., 706, 714a-714d in FIG. 7; 806, 814a-814c in FIG. 8). In aspects, at least one of the timing offset or the phase offset (e.g., 624 in FIG. 6) between the multiple antenna modules (e.g., 712a-712h in FIG. 7; 812a-812h in FIG. 8) of the logically combined set of antenna modules (e.g., 706, 714a-714d in FIG. 7; 806, 814a-814c in FIG. 8) may be based on the at least one CSI report 512 (e.g., 610, 610′ in FIG. 6). The network node (e.g., the base station 504) may be configured to transmit/provide, and the UE 502 may be configured to receive, an indication (e.g., 624 in FIG. 6) of the at least one of the timing offset or the phase offset (e.g., 624 in FIG. 6).

As the CSI-RS channel is common for multiple UEs in a wideband allocation for a network node (e.g., a base station, gNB, etc.), correction applied by the network node to dedicated configurations (e.g., PDSCH (e.g., 622 in FIG. 6)) for a UE, per its CSI report (e.g., 610, 610′ in FIG. 6), may also be communicated back to the UE itself. In this way, the UE is enabled to understand or be aware of how much delta is applied to its dedicated data with respect to the CSI-RS. Accordingly, aspects may provide for the indication (e.g., 624 in FIG. 6) of such information of time difference applied per TRP as a MAC-CE in PDSCH (e.g., 622 in FIG. 6) data. The value in the MAC-CE may point to a table which may indicate a delta applied to one TRP with respect to another TRP, and may be extended to multi-TRP systems.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to receive, from a network node, a CSI configuration, where the CSI configuration is indicative of a format associated with at least one CSI report. The component 198 may be configured to receive multiple CSI-RS transmissions during at least one CSI-RS occasion, where the multiple CSI-RS transmissions include a CSI-RS from each logically combined set of antenna modules of the network node. The component 198 may be configured to provide, for the network node, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion. The component 198 may be configured to receive, from the network node, a PDSCH from the logically combined set of antenna modules, where at least one of a timing offset or a phase offset between multiple antenna modules of the logically combined set of antenna modules is based on the at least one CSI report. The component 198 may be configured to receive, from the network node, an indication of the at least one of the timing offset, the phase offset, or an index to a data structure that comprises at least one of discrete timing or phase offset values associated with an RRC procedure. The component 198, to receive the multiple CSI-RS transmissions during the at least one CSI-RS occasion, may be configured to receive a first CSI-RS from a first pair of antennas of the network node during the first CSI-RS occasion, receive a second CSI-RS from a second pair of antennas of the network node during the second CSI-RS occasion, where the second pair of antennas is different from the first pair of antennas, and measure at least one of the relative timing offset associated with the CSI-RS or the relative phase offset associated with the first CSI-RS and the second CSI-RS. The component 198 may be configured to provide, for the network node, uplink signaling indicative of the relative timing offset associated with the multiple CSI-RS transmissions, where the uplink signaling includes at least one of a SRS or a PUSCH DMRS. The component 198, to receive the multiple CSI-RS transmissions during the at least one CSI-RS occasion, may be configured to receive a first instance of the CSI-RS, by the first pair of ports of the number of ports and from a first pair of antennas of the network node, during the first CSI occasion, receive a second instance of the CSI-RS, by the second pair of ports of the number of ports and from a second pair of antennas of the network node, during the second CSI occasion subsequent to the first CSI occasion, and measure at least one of the relative timing offset associated with the CSI-RS or the relative phase offset associated with the CSI-RS at the first instance of the CSI-RS and at the second instance of the CSI-RS. The component 198 may be configured to provide, for the network node via the at least one transceiver, uplink signaling indicative of the relative timing offset associated with the first instance of the CSI-RS and with the second instance of the CSI-RS, where the uplink signaling includes at least one of a SRS or a PUSCH DMRS. The component 198 may be further configured to perform any of the aspects described in connection with the flowcharts in any of FIGS. 9, 10 and/or any of the aspects performed by a UE for any of FIGS. 5-8. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving, from a network node, a CSI configuration, where the CSI configuration is indicative of a format associated with at least one CSI report. In the configuration, the apparatus 1104, and in particular the cellular baseband processor(s) 1124 and/or the application processor(s) 1106, may include means for receiving multiple CSI-RS transmissions during at least one CSI-RS occasion, where the multiple CSI-RS transmissions include a CSI-RS from each logically combined set of antenna modules of the network node. In the configuration, the apparatus 1104, and in particular the cellular baseband processor(s) 1124 and/or the application processor(s) 1106, may include means for providing, for the network node, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion. In one configuration, the apparatus 1104, and in particular the cellular baseband processor(s) 1124 and/or the application processor(s) 1106, may include means for receiving, from the network node, a PDSCH from the logically combined set of antenna modules, where at least one of a timing offset or a phase offset between multiple antenna modules of the logically combined set of antenna modules is based on the at least one CSI report. In one configuration, the apparatus 1104, and in particular the cellular baseband processor(s) 1124 and/or the application processor(s) 1106, may include means for receiving, from the network node, an indication of the at least one of the timing offset, the phase offset, or an index to a data structure that comprises at least one of discrete timing or phase offset values associated with an RRC procedure. In one configuration, the apparatus 1104, and in particular the cellular baseband processor(s) 1124 and/or the application processor(s) 1106, may include means for receiving the multiple CSI-RS transmissions during the at least one CSI-RS occasion, may be configured to receive a first CSI-RS from a first pair of antennas of the network node during the first CSI-RS occasion, receive a second CSI-RS from a second pair of antennas of the network node during the second CSI-RS occasion, where the second pair of antennas is different from the first pair of antennas, and measure at least one of the relative timing offset associated with the CSI-RS or the relative phase offset associated with the first CSI-RS and the second CSI-RS. In one configuration, the apparatus 1104, and in particular the cellular baseband processor(s) 1124 and/or the application processor(s) 1106, may include means for providing, for the network node, uplink signaling indicative of the relative timing offset associated with the multiple CSI-RS transmissions, where the uplink signaling includes at least one of a sounding reference signal (SRS) or a physical uplink shared channel (PUSCH) demodulation reference signal (DMRS). In one configuration, the apparatus 1104, and in particular the cellular baseband processor(s) 1124 and/or the application processor(s) 1106, for receiving the multiple CSI-RS transmissions during the at least one CSI-RS occasion, may include means for receiving a first instance of the CSI-RS, by the first pair of ports of the number of ports and from a first pair of antennas of the network node, during the first CSI occasion, receiving a second instance of the CSI-RS, by the second pair of ports of the number of ports and from a second pair of antennas of the network node, during the second CSI occasion subsequent to the first CSI occasion, and measuring at least one of the relative timing offset associated with the CSI-RS or the relative phase offset associated with the CSI-RS at the first instance of the CSI-RS and at the second instance of the CSI-RS. In one configuration, the apparatus 1104, and in particular the cellular baseband processor(s) 1124 and/or the application processor(s) 1106, may include means for providing, for the network node via the at least one transceiver, uplink signaling indicative of the relative timing offset associated with the first instance of the CSI-RS and with the second instance of the CSI-RS, where the uplink signaling includes at least one of a SRS or a PUSCH DMRS. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, for a UE, a CSI configuration, where the CSI configuration is indicative of a format associated with at least one CSI report. The component 199 may be configured to provide, for the UE, multiple CSI-RS transmissions during at least one CSI-RS occasion, where the multiple CSI-RS transmissions include a CSI-RS from each logically combined set of antenna modules of the network node. The component 199 may be configured to receive, from the UE, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion. The component 199 may be configured to calculate at least one of a timing offset or a phase offset between the multiple antenna modules of the logically combined set of antenna modules based on the at least one CSI report. The component 199 may be configured to provide, for the UE, a PDSCH from the logically combined set of antenna modules, where at least one of the timing offset or the phase offset between the multiple antenna modules of the logically combined set of antenna modules. The component 199 may be configured to provide, for the UE, an indication of the at least one of the timing offset, the phase offset, or an index to a data structure that comprises at least one of discrete timing or phase offset values associated with an RRC procedure. The component 199, to provide the multiple CSI-RS transmissions during the at least one CSI-RS occasions, may be configured to provide a first CSI-RS from a first pair of antennas of the network node during the first CSI-RS occasion, and provide a second CSI-RS from a second pair of antennas of the network node during the second CSI-RS occasion, where the second pair of antennas is different from the first pair of antennas, where at least one of the relative timing offset associated with the multiple CSI-RS transmissions or the relative phase offset associated with the multiple CSI-RS transmissions is associated with the first CSI-RS and the second CSI-RS. The component 199 may be configured to receive, from the UE, uplink signaling indicative of the relative timing offset associated with the multiple CSI-RS transmissions, where the uplink signaling includes at least one of a SRS or a PUSCH DMRS. The component 199, to provide the multiple CSI-RS transmissions during the at least one CSI-RS occasion, may be configured to provide a first instance of the CSI-RS, by the first pair of ports of the number of ports and from a first pair of antennas of the network node, during the first CSI occasion, and provide a second instance of the CSI-RS, by the second pair of ports of the number of ports and from a second pair of antennas of the network node, during the second CSI occasion subsequent to the first CSI occasion, where at least one of the relative timing offset associated with the CSI-RS or the relative phase offset associated with the CSI-RS is associated with the first instance of the CSI-RS and at the second instance of the CSI-RS. The component 199 may be configured to receive, from the UE via the at least one transceiver, uplink signaling indicative of the relative timing offset associated with the first instance of the CSI-RS and with the second instance of the CSI-RS, where the uplink signaling includes at least one of a SRS or a PUSCH DMRS. The component 199 may be further configured to perform any of the aspects described in connection with the flowcharts in any of FIGS. 9, 10 and/or any of the aspects performed by a network node, base station, gNB, etc., for any of FIGS. 5-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for providing, for a UE, a CSI configuration, where the CSI configuration is indicative of a format associated with at least one CSI report. In the configuration, the network entity 1202 may include means for providing, for the UE, multiple CSI-RS transmissions during at least one CSI-RS occasion, where the multiple CSI-RS transmissions include a CSI-RS from each logically combined set of antenna modules of the network node. In the configuration, the network entity 1202 may include means for receiving, from the UE, the at least one CSI report based on the format associated with the at least one CSI report and based on the CSI-RS, where the at least one CSI report is indicative of at least one of a relative timing offset associated with the multiple CSI-RS transmissions or a relative phase offset associated with the multiple CSI-RS transmissions during the at least one CSI-RS occasion. In one configuration, the network entity 1202 may include means for calculating at least one of a timing offset or a phase offset between multiple antenna modules of the logically combined set of antenna modules based on the at least one CSI report. In one configuration, the network entity 1202 may include means for providing, for the UE, a PDSCH from the logically combined set of antenna modules, where at least one of the timing offset or the phase offset between the multiple antenna modules of the logically combined set of antenna modules. In one configuration, the network entity 1202 may include means for providing, for the UE, an indication of the at least one of the timing offset, the phase offset, or an index to a data structure that comprises at least one of discrete timing or phase offset values associated with an RRC procedure. In one configuration, the network entity 1202, for providing the multiple CSI-RS transmissions during the at least one CSI-RS occasions, may include means for providing a first CSI-RS from a first pair of antennas of the network node during the first CSI-RS occasion, and providing a second CSI-RS from a second pair of antennas of the network node during the second CSI-RS occasion, where the second pair of antennas is different from the first pair of antennas, where at least one of the relative timing offset associated with the multiple CSI-RS transmissions or the relative phase offset associated with the multiple CSI-RS transmissions is associated with the first CSI-RS and the second CSI-RS. In one configuration, the network entity 1202 may include means for receiving, from the UE, uplink signaling indicative of the relative timing offset associated with the multiple CSI-RS transmissions, where the uplink signaling includes at least one of a SRS or a PUSCH DMRS. In one configuration, the network entity 1202, for providing the multiple CSI-RS transmissions during the at least one CSI-RS occasion, may include means for providing a first instance of the CSI-RS, by the first pair of ports of the number of ports and from a first pair of antennas of the network node, during the first CSI occasion, and providing a second instance of the CSI-RS, by the second pair of ports of the number of ports and from a second pair of antennas of the network node, during the second CSI occasion subsequent to the first CSI occasion, where at least one of the relative timing offset associated with the CSI-RS or the relative phase offset associated with the CSI-RS is associated with the first instance of the CSI-RS and at the second instance of the CSI-RS. In one configuration, the network entity 1202 may include means for receiving, from the UE via the at least one transceiver, uplink signaling indicative of the relative timing offset associated with the first instance of the CSI-RS and with the second instance of the CSI-RS, where the uplink signaling includes at least one of a SRS or a PUSCH DMRS. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

A network node, such as a base station, gNB, etc., and a UE in a wireless communication network may communicate in various communication configurations and using various communication components. As one example, a modem communicatively coupled to one or more antenna modules may transmit/receive wireless communications for network devices. Such communications may be transmitted according to an EIRP, and the EIRP may be limited by the hardware of communication components. Some configurations may combine communication components in an attempt to boost the EIRP. However, while the module alignment and factory calibration may provide for beams combining coherently, multi-path aspects of communications may still prevent signals from being received in-phase in order to provide a full amount of gain from communication components, such as two grouped RF modules. Additionally, the lack of flexibility to pre-code signals of two or more combined communication components in the digital domain, e.g., to have the signals be received in-phase, prevents the full benefit of the combination from being realized. For example, when the same data/signal is transmitted through combined communication components, such as for two layers scheduled for a UE, theoretically there will be a 2-port CSI-RS configuration for the UE to report the CSI back to the base station/gNB.

The aspects herein provide for independent sounding for two or more RF modules for increased EIRP. In some examples, a UE may receive multiple CSI-RS transmissions, such as a CSI-RS from logically combined sets of antenna modules of a network node, during a CSI-RS occasion(s), and provide, for the network node, a CSI report(s) based on a CSI configuration and the CSI-RS. The CSI report(s) is indicative of a relative timing offset and/or a relative phase offset associated with the multiple CSI-RS transmissions during the CSI-RS occasion(s). In one example, the CSI report(s) is more than one CSI report, such as when a number of CSI-RS ports configured at the UE is less than a number of logical ports of the logically combined sets of antenna modules, which provides indicia of the relative timing offset and/or the relative phase offset, and the network node may calculate a timing offset and/or a phase offset of its antenna modules and provide the UE with an indication thereof. In one example, the CSI report(s) is one CSI report, such as when the number of CSI-RS ports configured at the UE is equal to the number of logical ports, which provides the relative timing offset and/or the relative phase offset measured by the UE, and the network node may calculate a timing offset and/or a phase offset of its antenna modules and provide the UE with an indication thereof.

Aspects increase EIRP with existing communication components by enabling beams to combine coherently using independent sounding for two or more RF modules. Aspects also enhance in cell coverage and cell capacity with high throughput (e.g., multi-layer) transmissions, increase reliability, and reduce cost for UE/base station operations by increasing the EIRP. Aspects further improve adaptability per-UE for EIRP increases through timing/phase offset correction across antenna modules/ports by providing extensibility for the number of RF modules combined and carrier aggregation.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is method of wireless communication at a user equipment (UE), comprising: receiving, from a network node, a channel state information (CSI) configuration, wherein the CSI configuration is indicative of a format associated with at least one CSI report; receiving multiple channel state information reference signal (CSI-RS) transmissions during at least one CSI-RS occasion, wherein the multiple CSI-RS transmissions include a CSI-RS from each logically combined set of antenna modules of the network node; and providing, for the network node, the at least one CSI report based on the format associated with the at least one CSI report and based on the CSI-RS, wherein the at least one CSI report is indicative of at least one of a relative timing offset associated with the multiple CSI-RS transmissions or a relative phase offset associated with the multiple CSI-RS transmissions during the at least one CSI-RS occasion.

Aspect 2 is the method of aspect 1, further comprising: receiving, from the network node, a physical downlink shared channel (PDSCH) from the logically combined set of antenna modules, wherein at least one of a timing offset or a phase offset between the multiple antenna modules of the logically combined set of antenna modules is based on the at least one CSI report; and receiving, from the network node, an indication of the at least one of the timing offset, the phase offset, or an index to a data structure that comprises at least one of discrete timing or phase offset values associated with a radio resource control (RRC) procedure.

Aspect 3 is the method of aspect 2, wherein the indication is comprised in a medium access control (MAC) control element (MAC-CE) of a physical downlink shared channel (PDSCH).

Aspect 4 is he method of any of aspects 1 to 3, wherein the at least one CSI report is further indicative of a set of ports associated with the multiple CSI-RS transmissions.

Aspect 5 is the method of any of aspects 1 to 4, wherein the at least one CSI-RS occasion includes a first CSI-RS occasion and a second CSI-RS occasion; wherein the CSI configuration is indicative of at least four ports; wherein receiving the multiple CSI-RS transmissions during the at least one CSI-RS occasion includes: receiving a first CSI-RS from a first pair of antennas of the network node during the first CSI-RS occasion, receiving a second CSI-RS from a second pair of antennas of the network node during the second CSI-RS occasion, wherein the second pair of antennas is different from the first pair of antennas, and measuring at least one of the relative timing offset associated with the CSI-RS or the relative phase offset associated with the first CSI-RS and the second CSI-RS.

Aspect 6 is the method of aspect 5, wherein the first CSI-RS and the second CSI-RS comprise additional instances of the CSI-RS, wherein each of the additional instances of the CSI-RS correspond to pairs of different antenna modules of the network node; wherein the at least one CSI report includes a second number of CSI reports corresponding to each of the additional instances of the CSI-RS.

Aspect 7 is the method of aspect 5, wherein the CSI configuration is indicative of a number of CSI-RS ports associated with the UE; and wherein the second CSI-RS occasion is subsequent to the first CSI-RS occasion based on the number of CSI-RS ports associated with the UE being less than a number of antenna ports of the logically combined set of antenna modules of the network node, or wherein the second CSI-RS occasion is a same CSI-RS occasion as the first CSI-RS occasion.

Aspect 8 is the method of aspect 5, wherein the at least one CSI report is based on two layers and on four ports for the multiple CSI-RS transmissions, wherein the two layers are associated with a vertical polarization and a horizontal polarization; or wherein the at least one CSI report is indicative of an additional CSI metric associated with a precoding coefficient and the relative phase offset associated with the multiple CSI-RS transmissions.

Aspect 9 is the method of aspect 5, wherein the at least one CSI report is based on a single layer and on four ports for the multiple CSI-RS transmissions, wherein the single layer is associated with at least one of a vertical polarization, a horizontal polarization, or a circular polarization.

Aspect 10 is the method of aspect 5, wherein the at least one CSI report is based on at least four ports for the multiple CSI-RS transmissions, wherein one port of the at least four ports is a measurement reference port, wherein measuring at least one of the relative timing offset associated with the CSI-RS or the relative phase offset associated with the first CSI-RS and the second CSI-RS includes measuring on each other port of the at least four ports than the one port of the at least four ports.

Aspect 11 is the method of any of aspects 1 to 4, wherein a number of ports associated with the multiple CSI-RS transmissions is at least two ports that include a first pair of ports and a second pair of ports, wherein the at least one CSI occasion includes a first CSI occasion and a second CSI occasion; wherein receiving the multiple CSI-RS transmissions during the at least one CSI-RS occasion includes: receiving a first instance of the CSI-RS, by the first pair of ports of the number of ports and from a first pair of antennas of the network node, during the first CSI occasion, and receiving a second instance of the CSI-RS, by the second pair of ports of the number of ports and from a second pair of antennas of the network node, during the second CSI occasion subsequent to the first CSI occasion.

Aspect 12 is the method of aspect 11, wherein the at least one CSI report includes at least two CSI reports, wherein the at least two CSI reports are respectively indicative of the relative timing offset associated with the CSI-RS at the first instance and at the second instance; or wherein the at least two ports are associated with different pairs of antennas included in a same antenna module of the network node.

Aspect 13 is the method of aspect 11, wherein the at least one CSI report is based on two layers and on two ports for the CSI-RS, wherein the two layers are associated with a vertical polarization and a horizontal polarization; or wherein the at least one CSI report is based on a single layer and on four ports for the multiple CSI-RS transmissions, wherein the single layer is associated with at least one of a vertical polarization, a horizontal polarization, or a circular polarization.

Aspect 14 is the method of any of aspects 1 to 13, wherein the at least one CSI report is further indicative of at least one of a delay spread associated with the multiple CSI-RS transmissions or a set of ports associated with the multiple CSI-RS transmissions.

Aspect 15 is a method of wireless communication at a network node, comprising: providing, for a user equipment (UE), a channel state information (CSI) configuration, wherein the CSI configuration is indicative of a format associated with at least one CSI report; providing, for the UE, multiple channel state information reference signal (CSI-RS) transmissions during at least one CSI-RS occasion, wherein the multiple CSI-RS transmissions include a CSI-RS from each logically combined set of antenna modules of the network node; and receiving, from the UE, the at least one CSI report based on the format associated with the at least one CSI report and based on the CSI-RS, wherein the at least one CSI report is indicative of at least one of a relative timing offset associated with the multiple CSI-RS transmissions or a relative phase offset associated with the multiple CSI-RS transmissions during the at least one CSI-RS occasion.

Aspect 16 is the method of aspect 15, further comprising: calculating at least one of a timing offset or a phase offset between the multiple antenna modules of the logically combined set of antenna modules based on the at least one CSI report; providing, for the UE, a physical downlink shared channel (PDSCH) from the logically combined set of antenna modules, wherein at least one of the timing offset or the phase offset between the multiple antenna modules of the logically combined set of antenna modules; and providing, for the UE, an indication of at least one of the timing offset, the phase offset, or an index to a data structure that comprises at least one of discrete timing or phase offset values associated with a radio resource control (RRC) procedure.

Aspect 17 is the method of aspect 16, wherein the indication is comprised in a medium access control (MAC) control element (MAC-CE) of a physical downlink shared channel (PDSCH).

Aspect 18 is the method of any of aspects 15 to 17, wherein the at least one CSI report is further indicative of a set of ports associated with the multiple CSI-RS transmissions.

Aspect 19 is the method of any of aspects 15 to 18, wherein the at least one CSI-RS occasions include a first CSI-RS occasion and a second CSI-RS occasion; wherein the CSI configuration is indicative of at least four ports; wherein providing the multiple CSI-RS transmissions during the at least one CSI-RS occasions includes: providing a first CSI-RS from a first pair of antennas of the network node during the first CSI-RS occasion, and providing a second CSI-RS from a second pair of antennas of the network node during the second CSI-RS occasion, wherein the second pair of antennas is different from the first pair of antennas, wherein at least one of the relative timing offset associated with the multiple CSI-RS transmissions or the relative phase offset associated with the multiple CSI-RS transmissions is associated with the first CSI-RS and the second CSI-RS.

Aspect 20 is the method of aspect 19, wherein the first CSI-RS and the second CSI-RS comprise additional instances of the CSI-RS, wherein each of the additional instances of the CSI-RS correspond to pairs of different antenna modules of the network node; wherein the at least one CSI report includes a second number of CSI reports corresponding to each of the additional instances of the CSI-RS.

Aspect 21 is the method of aspect 19, wherein the CSI configuration is indicative of a number of CSI-RS ports associated with the UE; and wherein the second CSI-RS occasion is subsequent to the first CSI-RS occasion based on the number of CSI-RS ports associated with the UE being less than a number of antenna ports of the logically combined set of antenna modules of the network node, or wherein the second CSI-RS occasion is a same CSI-RS occasion as the first CSI-RS occasion.

Aspect 22 is the method of aspect 19, wherein the at least one CSI report is based on two layers and on four ports for the multiple CSI-RS transmissions, wherein the two layers are associated with a vertical polarization and a horizontal polarization; or wherein the at least one CSI report is indicative of an additional CSI metric associated with a precoding coefficient and the relative phase offset associated with the multiple CSI-RS transmissions.

Aspect 23 is the method of aspect 19, wherein the at least one CSI report is based on a single layer and on four ports for the multiple CSI-RS transmissions, wherein the single layer is associated with at least one of a vertical polarization, a horizontal polarization, or a circular polarization.

Aspect 24 is the method of aspect 19, wherein the at least one CSI report is based on at least four ports for the multiple CSI-RS transmissions, wherein one port of the at least four ports is a measurement reference port, wherein at least one of the relative timing offset associated with the CSI-RS or the relative phase offset associated with the first CSI-RS and the second CSI-RS includes a respective relative timing offset and a respective relative phase offset for each other port of the at least four ports than the one port of the at least four ports.

Aspect 25 is the method of any of aspects 15 to 18, wherein a number of ports associated with the multiple CSI-RS transmissions is at least two ports that include a first pair of ports and a second pair of ports, wherein the at least one CSI occasion includes a first CSI occasion and a second CSI occasion; wherein providing the multiple CSI-RS transmissions during the at least one CSI-RS occasion includes: providing a first instance of the CSI-RS, by the first pair of ports of the number of ports and from a first pair of antennas of the network node, during the first CSI occasion, and providing a second instance of the CSI-RS, by the second pair of ports of the number of ports and from a second pair of antennas of the network node, during the second CSI occasion subsequent to the first CSI occasion, wherein at least one of the relative timing offset associated with the CSI-RS or the relative phase offset associated with the CSI-RS is associated with the first instance of the CSI-RS and at the second instance of the CSI-RS.

Aspect 26 is the method of aspect 25, wherein the at least one CSI report includes at least two CSI reports, wherein the at least two CSI reports are respectively indicative of the relative timing offset associated with the CSI-RS; or wherein the at least two ports are associated with different pairs of antennas included in a same antenna module of the network node.

Aspect 27 is the method of aspect 25, wherein the at least one CSI report is based on two layers and on two ports for the CSI-RS, wherein the two layers are associated with a vertical polarization and a horizontal polarization; or wherein the at least one CSI report is based on a single layer and on four ports for the multiple CSI-RS transmissions, wherein the single layer is associated with at least one of a vertical polarization, a horizontal polarization, or a circular polarization.

Aspect 28 is the method of any of aspects 15 to 27, wherein the at least one CSI report is further indicative of a delay spread associated with the multiple CSI-RS transmissions a set of ports associated with the multiple CSI-RS transmissions.

Aspect 29 is an apparatus for wireless communication at a user equipment (UE), comprising: at least one memory; and at least one processor coupled to the at least one memory, the at least one processor, individually or in any combination, is configured to perform the method of any of aspects 1 to 14.

Aspect 30 is an apparatus for wireless communication at a user equipment (UE), comprising means for performing each step in the method of any of aspects 1 to 14.

Aspect 31 is the apparatus of any of aspects 29 and 30, further comprising a transceiver configured to receive or to transmit in association with the method of any of aspects 1 to 14.

Aspect 32 is a computer-readable medium (e.g., a non-transitory computer-readable medium) storing computer executable code a user equipment (UE), the code when executed by at least one processor causes the UE to perform the method of any of aspects 1 to 14.

Aspect 33 is an apparatus for wireless communication at a network node, comprising: at least one memory; and at least one processor coupled to the at least one memory, the at least one processor, individually or in any combination, is configured to perform the method of any of aspects 15 to 28.

Aspect 34 is an apparatus for wireless communication at a network node, comprising means for performing each step in the method of any of aspects 15 to 28.

Aspect 35 is the apparatus of any of aspects 33 and 34, further comprising a transceiver configured to receive or to transmit in association with the method of any of aspects 15 to 28.

Aspect 36 is a computer-readable medium (e.g., a non-transitory computer-readable medium) storing computer executable code a network node, the code when executed by at least one processor causes the UE to perform the method of any of aspects 15 to 28.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, a channel state information (CSI) configuration, wherein the CSI configuration is indicative of a format associated with at least one CSI report;
receive multiple channel state information reference signal (CSI-RS) transmissions during at least one CSI-RS occasion, wherein the multiple CSI-RS transmissions include a CSI-RS from each logically combined set of antenna modules of the network node; and
provide, for the network node, the at least one CSI report based on the format associated with the at least one CSI report and based on the CSI-RS, wherein the at least one CSI report is indicative of at least one of a relative timing offset associated with the multiple CSI-RS transmissions or a relative phase offset associated with the multiple CSI-RS transmissions during the at least one CSI-RS occasion.

2. The apparatus of claim 1, wherein the at least one processor, individually or in any combination, is further configured to:
receive, from the network node, a physical downlink shared channel (PDSCH) from the logically combined set of antenna modules, wherein at least one of a timing offset or a phase offset between the multiple antenna modules of the logically combined set of antenna modules is based on the at least one CSI report; and
receive, from the network node, an indication of the at least one of the timing offset, the phase offset, or an index to a data structure that comprises at least one of discrete timing or phase offset values associated with a radio resource control (RRC) procedure.

3. The apparatus of claim 2, wherein the indication is comprised in a medium access control (MAC) control element (MAC-CE) of a physical downlink shared channel (PDSCH).

4. The apparatus of claim 1, wherein the at least one CSI report is further indicative of a set of ports associated with the multiple CSI-RS transmissions.

5. The apparatus of claim 1, wherein the at least one CSI-RS occasion includes a first CSI-RS occasion and a second CSI-RS occasion;
wherein the CSI configuration is indicative of at least four ports;
wherein to receive the multiple CSI-RS transmissions during the at least one CSI-RS occasion, the at least one processor, individually or in any combination, is configured to:
receive a first CSI-RS from a first pair of antennas of the network node during the first CSI-RS occasion,
receive a second CSI-RS from a second pair of antennas of the network node during the second CSI-RS occasion, wherein the second pair of antennas is different from the first pair of antennas, and
measure at least one of the relative timing offset associated with the CSI-RS or the relative phase offset associated with the first CSI-RS and the second CSI-RS.

6. The apparatus of claim 5, wherein the first CSI-RS and the second CSI-RS comprise additional instances of the CSI-RS, wherein each of the additional instances of the CSI-RS correspond to pairs of different antenna modules of the network node;
wherein the at least one CSI report includes a second number of CSI reports corresponding to each of the additional instances of the CSI-RS.

7. The apparatus of claim 5, wherein the CSI configuration is indicative of a number of CSI-RS ports associated with the UE; and
wherein the second CSI-RS occasion is subsequent to the first CSI-RS occasion based on the number of CSI-RS ports associated with the UE being less than a number of antenna ports of the logically combined set of antenna modules of the network node, or
wherein the second CSI-RS occasion is a same CSI-RS occasion as the first CSI-RS occasion.

8. The apparatus of claim 5, wherein the at least one CSI report is based on two layers and on four ports for the multiple CSI-RS transmissions, wherein the two layers are associated with a vertical polarization and a horizontal polarization; or
wherein the at least one CSI report is indicative of an additional CSI metric associated with a precoding coefficient and the relative phase offset associated with the multiple CSI-RS transmissions.

9. The apparatus of claim 5, wherein the at least one CSI report is based on a single layer and on four ports for the multiple CSI-RS transmissions, wherein the single layer is associated with at least one of a vertical polarization, a horizontal polarization, or a circular polarization.

10. The apparatus of claim 5, wherein the at least one CSI report is based on at least four ports for the multiple CSI-RS transmissions, wherein one port of the at least four ports is a measurement reference port, wherein to measure at least one of the relative timing offset associated with the CSI-RS or the relative phase offset associated with the first CSI-RS and the second CSI-RS, the at least one processor, individually or in any combination, is configured to measure on each other port of the at least four ports than the one port of the at least four ports.

11. The apparatus of claim 1, wherein a number of ports associated with the multiple CSI-RS transmissions is at least two ports that include a first pair of ports and a second pair of ports, wherein the at least one CSI occasion includes a first CSI occasion and a second CSI occasion;
wherein to receive the multiple CSI-RS transmissions during the at least one CSI-RS occasion, the at least one processor, individually or in any combination, is configured to:
receive a first instance of the CSI-RS, by the first pair of ports of the number of ports and from a first pair of antennas of the network node, during the first CSI occasion, and
receive a second instance of the CSI-RS, by the second pair of ports of the number of ports and from a second pair of antennas of the network node, during the second CSI occasion subsequent to the first CSI occasion.

12. The apparatus of claim 11, wherein the at least one CSI report includes at least two CSI reports, wherein the at least two CSI reports are respectively indicative of the relative timing offset associated with the CSI-RS at the first instance and at the second instance; or
wherein the at least two ports are associated with different pairs of antennas included in a same antenna module of the network node.

13. The apparatus of claim 11, wherein the at least one CSI report is based on two layers and on two ports for the CSI-RS, wherein the two layers are associated with a vertical polarization and a horizontal polarization; or
wherein the at least one CSI report is based on a single layer and on four ports for the multiple CSI-RS transmissions, wherein the single layer is associated with at least one of a vertical polarization, a horizontal polarization, or a circular polarization.

14. The apparatus of claim 1, wherein the at least one CSI report is further indicative of at least one of a delay spread associated with the multiple CSI-RS transmissions or a set of ports associated with the multiple CSI-RS transmissions.

15. An apparatus for wireless communication at a network node, comprising:
at least one memory; and
at least one processor coupled to the at least one memory and, based at least in part on information stored in the at least one memory, the at least one processor, individually or in any combination, is configured to:
provide, for a user equipment (UE), a channel state information (CSI) configuration, wherein the CSI configuration is indicative of a format associated with at least one CSI report;
provide, for the UE, multiple channel state information reference signal (CSI-RS) transmissions during at least one CSI-RS occasion, wherein the multiple CSI-RS transmissions include a CSI-RS from each logically combined set of antenna modules of the network node; and
receive, from the UE, the at least one CSI report based on the format associated with the at least one CSI report and based on the CSI-RS, wherein the at least one CSI report is indicative of at least one of a relative timing offset associated with the multiple CSI-RS transmissions or a relative phase offset associated with the multiple CSI-RS transmissions during the at least one CSI-RS occasion.

16. The apparatus of claim 15, wherein the at least one processor, individually or in any combination, is further configured to:
calculate at least one of a timing offset or a phase offset between the multiple antenna modules of the logically combined set of antenna modules based on the at least one CSI report;
provide, for the UE, a physical downlink shared channel (PDSCH) from the logically combined set of antenna modules, wherein at least one of the timing offset or the phase offset between the multiple antenna modules of the logically combined set of antenna modules; and
provide, for the UE, an indication of at least one of the timing offset, the phase offset, or an index to a data structure that comprises at least one of discrete timing or phase offset values associated with a radio resource control (RRC) procedure.

17. The apparatus of claim 16, wherein the indication is comprised in a medium access control (MAC) control element (MAC-CE) of a physical downlink shared channel (PDSCH).

18. The apparatus of claim 15, wherein the at least one CSI report is further indicative of a set of ports associated with the multiple CSI-RS transmissions.

19. The apparatus of claim 15, wherein the at least one CSI-RS occasions include a first CSI-RS occasion and a second CSI-RS occasion;
wherein the CSI configuration is indicative of at least four ports;
wherein to provide the multiple CSI-RS transmissions during the at least one CSI-RS occasions, the at least one processor, individually or in any combination, is configured to:
provide a first CSI-RS from a first pair of antennas of the network node during the first CSI-RS occasion, and
provide a second CSI-RS from a second pair of antennas of the network node during the second CSI-RS occasion, wherein the second pair of antennas is different from the first pair of antennas,
wherein at least one of the relative timing offset associated with the multiple CSI-RS transmissions or the relative phase offset associated with the multiple CSI-RS transmissions is associated with the first CSI-RS and the second CSI-RS.

20. The apparatus of claim 19, wherein the first CSI-RS and the second CSI-RS comprise additional instances of the CSI-RS, wherein each of the additional instances of the CSI-RS correspond to pairs of different antenna modules of the network node;
wherein the at least one CSI report includes a second number of CSI reports corresponding to each of the additional instances of the CSI-RS.

21. The apparatus of claim 19, wherein the CSI configuration is indicative of a number of CSI-RS ports associated with the UE; and
wherein the second CSI-RS occasion is subsequent to the first CSI-RS occasion based on the number of CSI-RS ports associated with the UE being less than a number of antenna ports of the logically combined set of antenna modules of the network node, or
wherein the second CSI-RS occasion is a same CSI-RS occasion as the first CSI-RS occasion.

22. The apparatus of claim 19, wherein the at least one CSI report is based on two layers and on four ports for the multiple CSI-RS transmissions, wherein the two layers are associated with a vertical polarization and a horizontal polarization; or
wherein the at least one CSI report is indicative of an additional CSI metric associated with a precoding coefficient and the relative phase offset associated with the multiple CSI-RS transmissions.

23. The apparatus of claim 19, wherein the at least one CSI report is based on a single layer and on four ports for the multiple CSI-RS transmissions, wherein the single layer is associated with at least one of a vertical polarization, a horizontal polarization, or a circular polarization.

24. The apparatus of claim 19, wherein the at least one CSI report is based on at least four ports for the multiple CSI-RS transmissions, wherein one port of the at least four ports is a measurement reference port, wherein at least one of the relative timing offset associated with the CSI-RS or the relative phase offset associated with the first CSI-RS and the second CSI-RS includes a respective relative timing offset and a respective relative phase offset for each other port of the at least four ports than the one port of the at least four ports.

25. The apparatus of claim 15, wherein a number of ports associated with the multiple CSI-RS transmissions is at least two ports that include a first pair of ports and a second pair of ports, wherein the at least one CSI occasion includes a first CSI occasion and a second CSI occasion;
wherein to provide the multiple CSI-RS transmissions during the at least one CSI-RS occasion, the at least one processor, individually or in any combination, is configured to:
provide a first instance of the CSI-RS, by the first pair of ports of the number of ports and from a first pair of antennas of the network node, during the first CSI occasion, and
provide a second instance of the CSI-RS, by the second pair of ports of the number of ports and from a second pair of antennas of the network node, during the second CSI occasion subsequent to the first CSI occasion,
wherein at least one of the relative timing offset associated with the CSI-RS or the relative phase offset associated with the CSI-RS is associated with the first instance of the CSI-RS and at the second instance of the CSI-RS.

26. The apparatus of claim 25, wherein the at least one CSI report includes at least two CSI reports, wherein the at least two CSI reports are respectively indicative of the relative timing offset associated with the CSI-RS; or
wherein the at least two ports are associated with different pairs of antennas included in a same antenna module of the network node.

27. The apparatus of claim 25, wherein the at least one CSI report is based on two layers and on two ports for the CSI-RS, wherein the two layers are associated with a vertical polarization and a horizontal polarization; or
wherein the at least one CSI report is based on a single layer and on four ports for the multiple CSI-RS transmissions, wherein the single layer is associated with at least one of a vertical polarization, a horizontal polarization, or a circular polarization.

28. The apparatus of claim 15, wherein the at least one CSI report is further indicative of a delay spread associated with the multiple CSI-RS transmissions a set of ports associated with the multiple CSI-RS transmissions.

29. A method of wireless communication at a user equipment (UE), comprising:
receiving, from a network node, a channel state information (CSI) configuration, wherein the CSI configuration is indicative of a format associated with at least one CSI report;
receiving multiple channel state information reference signal (CSI-RS) transmissions during at least one CSI-RS occasion, wherein the multiple CSI-RS transmissions include a CSI-RS from each logically combined set of antenna modules of the network node; and
providing, for the network node, the at least one CSI report based on the format associated with the at least one CSI report and based on the CSI-RS, wherein the at least one CSI report is indicative of at least one of a relative timing offset associated with the multiple CSI-RS transmissions or a relative phase offset associated with the multiple CSI-RS transmissions during the at least one CSI-RS occasion.

30. A method of wireless communication at a network node, comprising:
providing, for a user equipment (UE), a channel state information (CSI) configuration, wherein the CSI configuration is indicative of a format associated with at least one CSI report;
providing, for the UE, multiple channel state information reference signal (CSI-RS) transmissions during at least one CSI-RS occasion, wherein the multiple CSI-RS transmissions include a CSI-RS from each logically combined set of antenna modules of the network node; and
receiving, from the UE, the at least one CSI report based on the format associated with the at least one CSI report and based on the CSI-RS, wherein the at least one CSI report is indicative of at least one of a relative timing offset associated with the multiple CSI-RS transmissions or a relative phase offset associated with the multiple CSI-RS transmissions during the at least one CSI-RS occasion.
